(19) United States
(12) Patent Application Publication
(10) Pub. No.: US 2025/0383005 A1
(43) Pub. Date: Dec. 18, 2025

(54) BUMPER CAP AND SHOCK ABSORBER

(71) Applicant: Hitachi Astemo, Ltd., Ibaraki (JP)

(72) Inventor: Masatomo HIRATA, Hitachinaka-shi (JP)

(21) Appl. No.: 18/878,163

(22) PCT Filed: May 26, 2023
(86) PCT No.: PCT/JP2023/019754

§ 371 Date: Dec. 23, 2024

(30) Foreign Application Priority Data
Jul. 8, 2022 (JP) 2022-110369

(51) Int. Cl. F16F 9/38; B60G 13/08; F16F 9/18; F16F 9/58

(52) U.S. Cl. CPC F16F 9/38; F16F 9/185; F16F 9/58; B60G 13/08; B60G 2202/24; B60G 2206/41; B60G 2206/8101; B60G 2206/81012; B60G 2800/162; F16F 2222/12; F16F 2226/04; F16F 2230/0023; F16F 2234/02

(57) ABSTRACT

A bumper cap is used for a shock absorber. The shock absorber includes a cylinder, a piston and piston rod. The bumper cap is at an end part of the cylinder on a side from which the piston rod extends and is formed by die casting or injection molding, and includes a lid coming into contact with an axial end surface of the cylinder and having a through hole through which the piston rod is inserted. A cylindrical portion has a cylindrical shape provided radially outward from the through hole and an outer circumferential surface of the cylinder. A communication hole in the cylindrical portion permits communication between inner and outer circumferential surfaces of the cylindrical portion. An edge of the communication hole is narrower on the first end part side positioned downstream than at the second end part positioned upstream through which a material flows in during molding.

### TECHNICAL FIELD

The present invention relates to a bumper cap and a shock absorber.

Priority is claimed on Japanese Patent Application No. 2022-110369, filed Jul. 8, 2022, the content of which is incorporated herein by reference.

### BACKGROUND ART

In some shock absorbers, a side of a cylinder from which a rod protrudes is covered with a bumper cap (see, for example, Patent Document 1).

### CITATION LIST

### Patent Document

Patent Document 1: Japanese Unexamined Patent Application, First Publication No. 2016-061425

### SUMMARY OF INVENTION

### Technical Problem

In a shock absorber, it is desired to improve durability of a bumper cap.

Therefore, an objective of the present invention is to provide a bumper cap and a shock absorber in which durability can be improved.

### Solution to Problem

In order to achieve the above-described objective, one aspect of the present invention adopts a configuration of a bumper cap used for a shock absorber, in which the shock absorber includes a cylinder, a piston provided in the cylinder, and a piston rod having a first end part connected to the piston and a second end part extending from the cylinder, and the bumper cap is provided at an end part of the cylinder on a side from which the piston rod extends and formed by die casting or injection molding, and includes a lid portion coming into contact with an axial end surface of the cylinder and having a through hole through which the piston rod is inserted, a cylindrical portion having a cylindrical shape provided radially outward from the through hole and covering at least a part of an outer circumferential surface of the cylinder, and a communication hole provided in the cylindrical portion and allowing communication between an inner circumferential surface and an outer circumferential surface of the cylindrical portion, in which an edge of the communication hole is narrower on the first end part side positioned downstream than at the second end part positioned upstream through which a material flows in during molding.

Another aspect of the present invention adopts a configuration of a bumper cap which is a bumper cap for a shock absorber including a cylinder, a piston provided in the cylinder, and a piston rod having one end connected to the piston and another end extending from the cylinder, and which is provided at an end part of the cylinder on a side from which the piston rod extends, and the bumper cap includes a lid portion coming into contact with an axial end surface of the cylinder and having a through hole through which the piston rod is inserted, a cylindrical portion having a cylindrical shape provided radially outward from the through hole and covering at least a part of an outer circumferential surface of the cylinder, and a communication hole provided in the cylindrical portion and allowing communication between an inner circumferential surface and an outer circumferential surface of the cylindrical portion, in which an edge of the communication hole includes a circumferential edge portion extending in a circumferential direction of the cylindrical portion, and an axial edge portion extending in an axial direction of the cylindrical portion, and at least a part of the circumferential edge portion includes an inclined portion formed to be inclined with respect to the axial direction of the cylindrical portion and serving as an end part side of the edge of the communication hole in the axial direction of the cylindrical portion.

Yet another aspect of the present invention adopts a configuration of a shock absorber including a cylinder, a piston provided in the cylinder, a piston rod having one end connected to the piston and another end extending from the cylinder, and a bumper cap, in which the bumper cap includes a lid portion coming into contact with an axial end surface of the cylinder and having a through hole through which the piston rod is inserted, a cylindrical portion having a cylindrical shape provided at a radially outer end part of the lid portion and covering at least a part of an outer circumferential surface of the cylinder, and a communication hole provided in the cylindrical portion and allowing communication between an inner circumferential surface and an outer circumferential surface of the cylindrical portion, and the communication hole is narrower on a first end part side positioned downstream than at a second end part positioned upstream through which a material flows in during molding.

### Advantageous Effects of Invention

According to each of the above-described aspects of the present invention, durability of a bumper cap can be improved.

### BRIEF DESCRIPTION OF DRAWINGS

FIG. 1 is a front view showing a shock absorber including a bumper cap of a first embodiment according to the present invention with a part thereof cross-sectioned.

FIG. 2 is an enlarged perspective view showing a main part of the shock absorber including the bumper cap of the first embodiment.

FIG. 3 is a development view showing a communication hole of the bumper cap of the shock absorber of the first embodiment.

FIG. 4 is a developed cross-sectional view showing a mold portion for forming the communication hole of a mold for forming the bumper cap of the shock absorber of the first embodiment.

FIG. 5 is a development view showing a communication hole of a bumper cap of a shock absorber of a second embodiment according to the present invention.

FIG. 6 is a development view showing a communication hole of a bumper cap of a shock absorber of a third embodiment according to the present invention.

FIG. 7 is a development view showing a communication hole of a bumper cap of a shock absorber of a fourth embodiment according to the present invention.

FIG. 8 is a development view showing a communication hole of a bumper cap of a shock absorber of a fifth embodiment according to the present invention.

FIG. 9 is a development view showing a communication hole of a bumper cap of a shock absorber of a sixth embodiment according to the present invention.

FIG. 10 is a development view showing a communication hole of a bumper cap of a shock absorber of a seventh embodiment according to the present invention.

FIG. 11 is a development view showing a communication hole of a bumper cap of a shock absorber of an eighth embodiment according to the present invention.

FIG. 12 is a development view showing a communication hole of a bumper cap of a shock absorber of a ninth embodiment according to the present invention.

### DESCRIPTION OF EMBODIMENTS

### First Embodiment

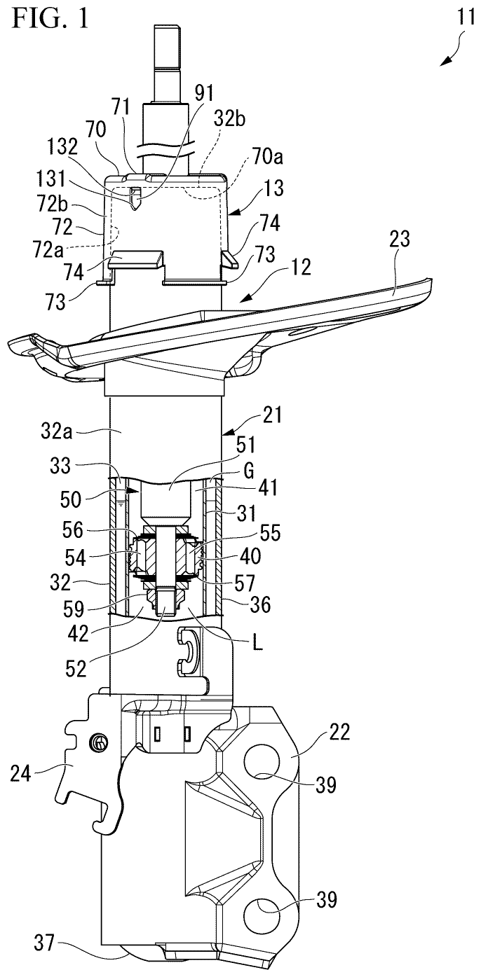

A first embodiment of the present invention will be described below with reference to FIGS. 1 to 4.

FIG. 1 shows a shock absorber according to the first embodiment. A shock absorber 11 of the present first embodiment is dual-tube type hydraulic shock absorber. The shock absorber 11 is used for a vehicle, specifically, for a strut-type suspension device of an automobile. The shock absorber 11 includes a shock absorber main body 12 and a bumper cap 13.

The shock absorber main body 12 includes a cylinder 21, a main bracket 22, a spring seat 23, and a sub-bracket 24.

The cylinder 21 includes an inner cylinder 31 and an outer cylinder 32, both of which are made of a metal. The inner cylinder 31 is cylindrical. The outer cylinder 32 has a bottomed cylindrical shape. The inner cylinder 31 is disposed radially inward of the outer cylinder 32. A reservoir chamber 33 is formed between the inner cylinder 31 and the outer cylinder 32. In the cylinder 21, an oil fluid Lis sealed as a working fluid in the inner cylinder 31, and the oil fluid L and a gas G are sealed as a working fluid in the reservoir chamber 33.

The outer cylinder 32 has a cylindrical barrel portion 36 and a bottom portion 37 that closes one end side of the barrel portion 36 in an axial direction. The outer cylinder 32 has an opening at an end part of the barrel portion 36 on a side opposite to the bottom portion 37 in the axial direction.

The main bracket 22 is made of a metal, and is fitted to the barrel portion 36 on the bottom portion 37 side with respect to a center position in the axial direction of the outer cylinder 32 and fixed by welding. The main bracket 22 is connected to a wheel (not shown) side of the vehicle with fasteners (not shown) inserted into a plurality of attachment holes 39.

The spring seat 23 is made of a metal, and is fitted to the barrel portion 36 on a side opposite to the bottom portion 37 with respect to the center position in the axial direction of the outer cylinder 32 and fixed by welding. The spring seat 23 supports a lower end of a vehicle body support spring (not shown) which is a coil spring that supports the vehicle body (not shown).

The sub-bracket 24 is made of a metal and is fixed to an outer circumferential side of the main bracket 22 by welding. The sub-bracket 24 supports a harness, a hose, and the like routed around the shock absorber 11.

The shock absorber main body 12 has a piston 40 provided in the cylinder 21. The piston 40 is slidably fitted into the inner cylinder 31 of the cylinder 21. The piston 40 partitions a first chamber 41 and a second chamber 42 in the inner cylinder 31. The first chamber 41 is provided on a side opposite to the bottom portion 37 with respect to the piston 40 in the axial direction of the inner cylinder 31. The second chamber 42 is provided on the bottom portion 37 side with respect to the piston 40 in the axial direction of the inner cylinder 31.

The shock absorber main body 12 includes a piston rod 50. A first end part of the piston rod 50 at one end in the axial direction is disposed in the inner cylinder 31 of the cylinder 21. The first end part of the piston rod 50 is connected to the piston 40. A second end part of the piston rod 50 at the other end on a side opposite to the first end part in the axial direction extends from the cylinder 21 to the outside of the cylinder 21.

The piston rod 50 has a main shaft portion 51 and a mounting shaft portion 52. Both the main shaft portion 51 and the mounting shaft portion 52 have a rod shape. The mounting shaft portion 52 has an outer diameter smaller than an outer diameter of the main shaft portion 51. The mounting shaft portion 52 is disposed inside the inner cylinder 31. The piston 40 is mounted on the mounting shaft portion 52 of the piston rod 50. The piston 40 moves integrally with the piston rod 50.

The piston 40 includes a passage 54 and a passage 55 formed to penetrate in the axial direction. Both the passage 54 and the passage 55 allow communication between the first chamber 41 and the second chamber 42.

The shock absorber main body 12 includes a disc valve 56 and a disc valve 57.

The disc valve 56 is provided on a side of the piston 40 opposite to the bottom portion 37 in the axial direction. The disc valve 56 is capable of closing the passage 54 by coming into contact with the piston 40.

The disc valve 57 is provided on the bottom portion 37 side of the piston 40 in the axial direction. The disc valve 57 is capable of closing the passage 55 by coming into contact with the piston 40. The disc valve 56 and the disc valve 57, together with the piston 40, are attached to the mounting shaft portion 52 of the piston rod 50 by a nut 59.

The disc valve 56 opens the passage 54 and allows the oil fluid L to flow when the piston rod 50 moves to a compression side that increases an amount of entry into the cylinder 21 to move the piston 40 in a direction in which the second chamber 42 is reduced and a pressure in the second chamber 42 becomes higher than a pressure in the first chamber 41 by a predetermined value or more. At that time, the disc valve 56 generates a damping force. A fixed orifice (not shown) that allows the first chamber 41 and the second chamber 42 to communicate with each other via the passage 54 even in a state in which the disc valve 56 has closed the passage 54 to the maximum is formed in at least one of the piston 40 and the disc valve 56.

The disc valve 57 opens the passage 55 and allows the oil fluid L to flow when the piston rod 50 moves to an extension side that increases an amount of protrusion from the cylinder 21 to move the piston 40 in a direction in which the first chamber 41 is reduced and a pressure in the first chamber 41 becomes higher than a pressure in the second chamber 42 by a predetermined value or more. At that time, the disc valve 57 generates a damping force. A fixed orifice (not shown) that allows the first chamber 41 and the second chamber 42 to communicate with each other via the passage 55 even in a state in which the disc valve 57 has closed the passage 55 to the maximum is formed in at least one of the piston 40 and the disc valve 57.

The bumper cap 13 is provided at an end part of the cylinder 21 on a side from which the piston rod 50 extends to cover the end part. Here, the shock absorber main body 12 has a seal member (not shown) that seals a gap between the cylinder 21 and the piston rod 50 at an outer end part of the cylinder 21 on a side from which the piston rod 50 protrudes. The bumper cap 13 covers and protects the seal member.

Here, when the shock absorber 11 is attached to the vehicle, a bump rubber (not shown) is provided on a portion of the piston rod 50 that protrudes outward from the seal member in the axial direction. The bump rubber is made of a cylindrical elastic material, and the piston rod 50 is inserted inside the bump rubber. When the cylinder 21 of the shock absorber main body 12 reduces a distance from the vehicle body (not shown), the bumper rubber comes into contact with the vehicle body and the bumper cap 13 and elastically deforms to absorb the impact. At that time, the bumper cap 13 inhibits a collision between the bump rubber and the seal member (not shown). Also, the bumper cap 13 suppresses adhesion of dust or the like to the seal member (not shown) from the outside.

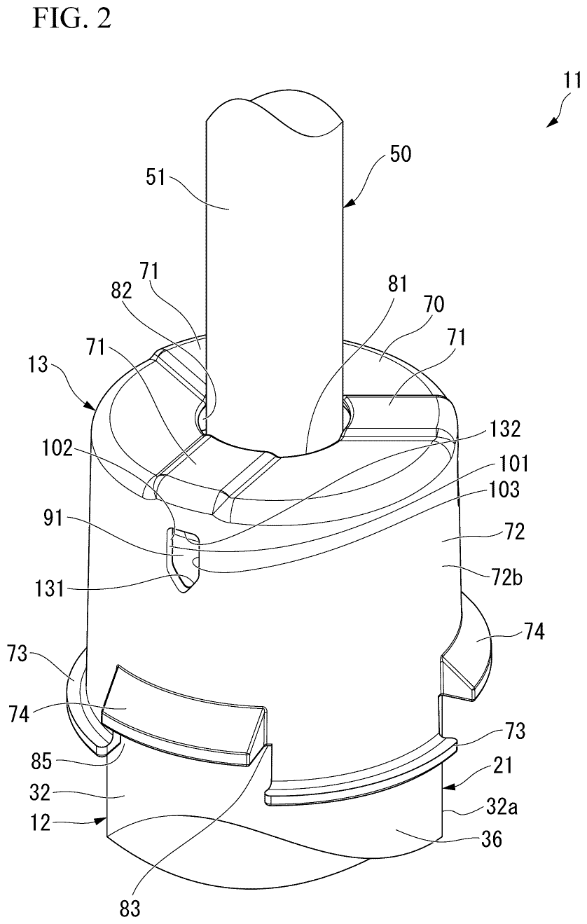

The bumper cap 13 used in the shock absorber 11 has a covered cylindrical shape. As shown in FIG. 2, the bumper cap 13 includes a lid portion 70, an axial protruding portion 71, a cylindrical portion 72, a flange portion 73, and a radial protruding portion 74.

The lid portion 70 has a bored disc shape, and has a through hole 81 that penetrates in the axial direction at a center in a radial direction. The through hole 81 is a circular round hole. In other words, in the lid portion 70, an inner circumferential edge portion 82 of the through hole 81 has a circular shape.

The axial protruding portion 71 protrudes from the lid portion 70 to one side in the axial direction of the lid portion 70. The axial protruding portion 71 is provided partially in a circumferential direction of the lid portion 70. The axial protruding portion 71 linearly extends outward in a radial direction of the lid portion 70 from the inner circumferential edge portion 82 of the lid portion 70. A plurality of, specifically three, axial protruding portions 71 of the same shape are provided on the bumper cap 13 on the same axial side of the lid portion 70 at regular intervals in the circumferential direction of the lid portion 70.

The cylindrical portion 72 has a cylindrical shape and extends coaxially with the lid portion 70 from an entire circumference of an outer circumferential edge portion of the lid portion 70 to a side opposite to the axial protruding portion 71 in the axial direction of the lid portion 70. In other words, the cylindrical portion 72 is provided at a radially outer end part of the lid portion 70. The cylindrical portion 72 is provided radially outward from the through hole 81 provided at a radial center of the lid portion 70. A recessed portion 83 recessed in the axial direction from an end surface on a side opposite to the lid portion 70 in the axial direction is provided in the cylindrical portion 72 at an end part on a side opposite to the lid portion 70 in the axial direction. The recessed portion 83 penetrates the cylindrical portion 72 in a radial direction of the cylindrical portion 72. A plurality of, specifically three, recessed portions 83 of the same shape are provided in the cylindrical portion 72 at predetermined regular intervals in a circumferential direction of the cylindrical portion 72. The recessed portions 83 are aligned in phase with one of the axial protruding portions 71 in the circumferential direction of the cylindrical portion 72. The cylindrical portion 72 has an opening 85 on a side opposite to the lid portion 70 in the axial direction. The opening 85 includes the plurality of recessed portions 83. In the bumper cap 13, the opening 85 is provided at one end in the axial direction, and the axial protruding portion 71, the lid portion 70, and the through hole 81 penetrating the lid portion 70 are provided at the other end in the axial direction.

Here, a central axis of the through hole 81, the lid portion 70, and the cylindrical portion 72 which are disposed coaxially is defined as a central axis of the bumper cap 13. Therefore, the through hole 81, the lid portion 70, the cylindrical portion 72, and the bumper cap 13 are aligned in the axial direction, the circumferential direction, and the radial direction.

The flange portion 73 protrudes outward in the radial direction of the cylindrical portion 72 from an end edge portion of the cylindrical portion 72 on a side opposite to the lid portion 70 in the axial direction. The flange portion 73 is provided partially in the circumferential direction of the cylindrical portion 72. The flange portion 73 is formed between adjacent recessed portions 83 of the end edge portion of the cylindrical portion 72 on a side opposite to the lid portion 70 in the axial direction. In the bumper cap 13, a plurality of, specifically three, flange portions 73 of the same shape are provided at regular intervals in the circumferential direction of the cylindrical portion 72. These flange portions 73 are aligned in position in the axial direction of the cylindrical portion 72.

The radial protruding portion 74 protrudes outward in the radial direction of the cylindrical portion 72 from between the lid portion 70 and the flange portion 73 in the axial direction of the cylindrical portion 72. The radial protruding portion 74 is provided partially in the circumferential direction of the cylindrical portion 72. The radial protruding portion 74 is provided at a position of the recessed portion 83 in the end edge portion in the axial direction of the cylindrical portion 72 on a side opposite to the lid portion 70. In the bumper cap 13, a plurality of, specifically three, radial protruding portions 74 of the same shape are provided at regular intervals in the circumferential direction of the cylindrical portion 72. These radial protruding portions 74 are aligned in position in the axial direction of the cylindrical portion 72. The radial protruding portions 74 are aligned in phase with one of the axial protruding portion 71 in the circumferential direction of the lid portion 70. The radial protruding portion 74 is positioned differently from the flange portion 73 in the circumferential direction of the cylindrical portion 72. The radial protruding portions 74 and the flange portions 73 are alternately disposed at regular intervals in the circumferential direction of the cylindrical portion 72.

The cylindrical portion 72 includes a communication hole 91 formed to penetrate the cylindrical portion 72 in the radial direction of the cylindrical portion 72 at a position between the radial protruding portion 74 and the lid portion 70 in the axial direction of the cylindrical portion 72. In other words, the communication hole 91 is provided in the cylindrical portion 72 and allows communication between an inner circumferential surface 72a and an outer circumferential surface 72b of the cylindrical portion 72 shown in FIG. 1. The communication hole 91 is a lateral hole that penetrates the cylindrical portion 72 in the radial direction of the bumper cap 13. In the bumper cap 13, a plurality of, specifically three, communication holes 91 of the same shape are provided at regular intervals in the circumferential direction of the cylindrical portion 72. These communication holes 91 are aligned in position in the axial direction of the cylindrical portion 72. The communication holes 91 are aligned in phase with one of the radial protruding portions 74 in the circumferential direction of the cylindrical portion 72.

An edge 101 of the communication hole 91 has a closed loop shape.

As shown in FIG. 2, the edge 101 has a first axial edge portion 102 and a second axial edge portion 103 as axial edge portions extending in the axial direction of the cylindrical portion 72. The first axial edge portion 102 and the second axial edge portion 103 are aligned in position in the axial direction of the cylindrical portion 72, spaced apart in the circumferential direction of the cylindrical portion 72, and are mirror symmetrical. Here, in the bumper cap 13, a side opposite to the lid portion 70 in the axial direction of the cylindrical portion 72 is referred to as a first end part side, and the lid portion 70 side in the axial direction of the cylindrical portion 72 is referred to as a second end part side. Also, in the communication hole 91, an end part on a side opposite to the lid portion 70 in the axial direction of the cylindrical portion 72 is referred to as a first end part, and an end part on the lid portion 70 side in the axial direction of the cylindrical portion 72 is referred to as a second end part.

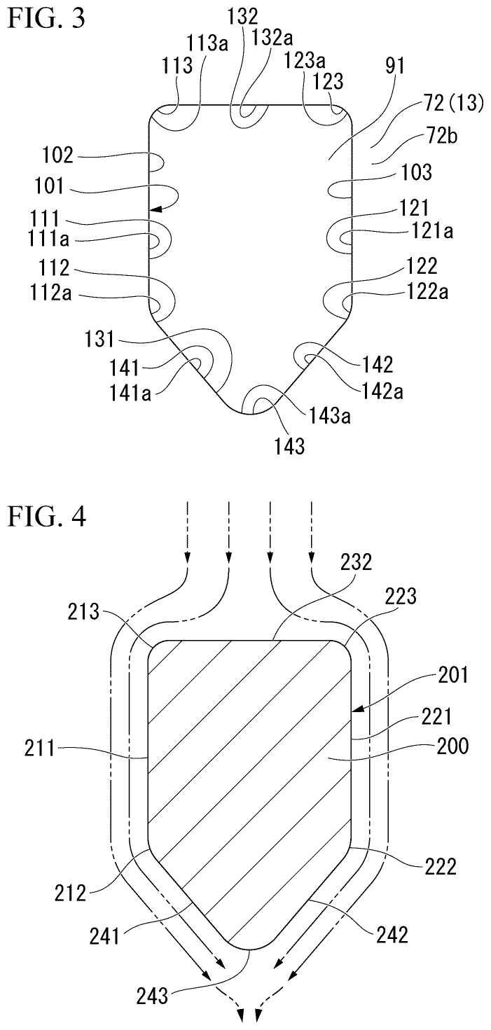

As shown in FIG. 3, the first axial edge portion 102 has a first straight portion 111, a first chamfered portion 112, and a second chamfered portion 113.

The first straight portion 111, including an inner surface 111a that faces a space in the communication hole 91, extends linearly in the axial direction of the cylindrical portion 72. The inner surface 111a of the first straight portion 111 also extends in the radial direction of the cylindrical portion 72 and is flat.

The first chamfered portion 112 extends in a direction of the first end part from an end part of the first straight portion 111 on the first end part side in the axial direction of the cylindrical portion 72. An inner surface 112a of the first chamfered portion 112 facing the space in the communication hole 91 extends in the direction of the first end part from an end part of the inner surface 111a of the first straight portion 111 on the first end part side in the axial direction of the cylindrical portion 72. The first chamfered portion 112, including the inner surface 112a, has an arc shape with its center on the second axial edge portion 103 side in the circumferential direction of the cylindrical portion 72 with respect to the inner surface 112a. The first chamfered portion 112 is a round chamfer. The first chamfered portion 112, including the inner surface 112a, approaches the second axial edge portion 103 in the circumferential direction of the cylindrical portion 72 as it is positioned further on the first end part side in the axial direction of the cylindrical portion 72. The inner surface 112a of the first chamfered portion 112 also extends in the radial direction of the cylindrical portion 72 and has a cylindrical surface shape.

The second chamfered portion 113 extends in a direction of the second end part from an end part of the first straight portion 111 on the second end part side in the axial direction of the cylindrical portion 72. An inner surface 113a of the second chamfered portion 113 facing the space in the communication hole 91 extends in the direction of the second end part from an end part of the inner surface 111a of the first straight portion 111 on the second end part side in the axial direction of the cylindrical portion 72. The second chamfered portion 113, including the inner surface 113a, has an arc shape with its center on the second axial edge portion 103 side in the circumferential direction of the cylindrical portion 72 with respect to the inner surface 113a. The second chamfered portion 113 is a round chamfer. The second chamfered portion 113, including the inner surface 113a, approaches the second axial edge portion 103 in the circumferential direction of the cylindrical portion 72 as it is positioned further on the second end part side in the axial direction of the cylindrical portion 72. The inner surface 113a of the second chamfered portion 113 also extends in the radial direction of the cylindrical portion 72 and has a cylindrical surface shape.

The second axial edge portion 103 has a second straight portion 121, a third chamfered portion 122, and a fourth chamfered portion 123.

The second straight portion 121, including an inner surface 121a that faces the space in the communication hole 91, extends linearly in the axial direction of the cylindrical portion 72. The inner surface 121a of the second straight portion 121 also extends in the radial direction of the cylindrical portion 72 and is flat. The second straight portion 121 is aligned with the first straight portion 111 in position in the axial direction of the cylindrical portion 72 and is spaced apart from the first straight portion 111 in the circumferential direction of the cylindrical portion 72 to form a mirror symmetrical shape.

The third chamfered portion 122 extends in the direction of the first end part from an end part of the second straight portion 121 on the first end part side in the axial direction of the cylindrical portion 72. An inner surface 122a of the third chamfered portion 122 facing the space in the communication hole 91 extends in the direction of the first end part from an end part of the inner surface 121a of the second straight portion 121 on the first end part side in the axial direction of the cylindrical portion 72. The third chamfered portion 122, including the inner surface 122a, has an arc shape with its center on the first axial edge portion 102 side in the circumferential direction of the cylindrical portion 72 with respect to the inner surface 122a. The third chamfered portion 122 is a round chamfer. The third chamfered portion 122, including the inner surface 122a, approaches the first axial edge portion 102 in the circumferential direction of the cylindrical portion 72 as it is positioned further on the first end part side in the axial direction of the cylindrical portion 72. The inner surface 122a of the third chamfered portion 122 also extends in the radial direction of the cylindrical portion 72 and has a cylindrical surface shape. The third chamfered portion 122 is aligned with the first chamfered portion 112 in position in the axial direction of the cylindrical portion 72 and is spaced apart from the first chamfered portion 112 in the circumferential direction of the cylindrical portion 72 to form a mirror symmetrical shape.

The fourth chamfered portion 123 extends in the direction of the second end part from an end part of the second straight portion 121 on the second end part side in the axial direction of the cylindrical portion 72. An inner surface 123a of the fourth chamfered portion 123 facing the space in the communication hole 91 extends in the direction of the second end part from an end part of the inner surface 121a of the second straight portion 121 on the second end part side in the axial direction of the cylindrical portion 72. The fourth chamfered portion 123, including the inner surface 123a, has an arc shape with its center on the first axial edge portion 102 side in the circumferential direction of the cylindrical portion 72 with respect to the inner surface 123a. The fourth chamfered portion 123 is a round chamfer. The fourth chamfered portion 123, including the inner surface 123a, approaches the first axial edge portion 102 in the circumferential direction of the cylindrical portion 72 as it is positioned further on the second end part side in the axial direction of the cylindrical portion 72. The inner surface 123a of the fourth chamfered portion 123 also extends in the radial direction of the cylindrical portion 72 and has a cylindrical surface shape. The fourth chamfered portion 123 is aligned with the second chamfered portion 113 in position in the axial direction of the cylindrical portion 72 and is spaced apart from the second chamfered portion 113 in the circumferential direction of the cylindrical portion 72 to form a mirror symmetrical shape.

The edge 101 has a first circumferential edge portion 131 and a second circumferential edge portion 132 as circumferential edge portions extending in the circumferential direction of the cylindrical portion 72. The edge 101 has the first circumferential edge portion 131 at an end part on the first end part side in the axial direction of the cylindrical portion 72. The edge 101 has the second circumferential edge portion 132 at an end part on the second end part side in the axial direction of the cylindrical portion 72.

The first circumferential edge portion 131 has a mirror-symmetrical shape, and includes a first inclined portion 141, a second inclined portion 142, and a fifth chamfered portion 143.

The first inclined portion 141 is formed to extend from one end of the first axial edge portion 102 on the first end part side in the axial direction of the cylindrical portion 72 to be inclined with respect to the first straight portion 111 of the first axial edge portion 102. The first inclined portion 141, including an inner surface 141a that faces the space in the communication hole 91, is linear. The inner surface 141a of the first inclined portion 141 also extends in the radial direction of the cylindrical portion 72 and is flat.

The first inclined portion 141 extends in the direction of the first end part in the axial direction of the cylindrical portion 72 from one end of the first chamfered portion 112 on the first end part side in the axial direction of the cylindrical portion 72. Moreover, the first inclined portion 141 approaches the second straight portion 121 in the circumferential direction of the cylindrical portion 72 as it is positioned further on the first end part side in the axial direction of the cylindrical portion 72. The inner surface 141a of the first inclined portion 141 extends from one end of the inner surface 112a of the first chamfered portion 112 on the first end part side in the axial direction of the cylindrical portion 72 to the first end part side in the axial direction of the cylindrical portion 72. Moreover, the inner surface 141a of the first inclined portion 141 approaches the second straight portion 121 in the circumferential direction of the cylindrical portion 72 as it is positioned further on the first end part side in the axial direction of the cylindrical portion 72.

The second inclined portion 142 is formed to extend from one end of the second axial edge portion 103 on the first end part side in the axial direction of the cylindrical portion 72 to be inclined with respect to the second straight portion 121 of the second axial edge portion 103. The second inclined portion 142, including an inner surface 142a that faces the space in the communication hole 91, is linear. The inner surface 142a of the second inclined portion 142 also extends in the radial direction of the cylindrical portion 72 and is flat.

The second inclined portion 142 extends in the direction of the first end part in the axial direction of the cylindrical portion 72 from one end of the third chamfered portion 122 on the first end part side in the axial direction of the cylindrical portion 72. Moreover, the second inclined portion 142 approaches the first straight portion 111 in the circumferential direction of the cylindrical portion 72 as it is positioned further on the first end part side in the axial direction of the cylindrical portion 72. The inner surface 142a of the second inclined portion 142 extends from one end of the inner surface 122a of the third chamfered portion 122 on the first end part side in the axial direction of the cylindrical portion 72 to the first end part side in the axial direction of the cylindrical portion 72. Moreover, the inner surface 142a of the second inclined portion 142 approaches the first straight portion 111 in the circumferential direction of the cylindrical portion 72 as it is positioned further on the first end part side in the axial direction of the cylindrical portion 72. The second inclined portion 142 is aligned with the first inclined portion 141 in position in the axial direction of the cylindrical portion 72 and is spaced apart from the first inclined portion 141 in the circumferential direction of the cylindrical portion 72 to form a mirror symmetrical shape. An angle formed by the inner surface 142a of the second inclined portion 142 and the inner surface 141a of the first inclined portion 141 is an acute angle.

The fifth chamfered portion 143 connects one end of the first inclined portion 141 on the first end part side in the axial direction of the cylindrical portion 72 and one end of the second inclined portion 142 on the first end part side in the axial direction of the cylindrical portion 72. An inner surface 143a of the fifth chamfered portion 143 facing the space in the communication hole 91 connects one end of the inner surface 141a of the first inclined portion 141 on the first end part side in the axial direction of the cylindrical portion 72 and one end of the inner surface 142a of the second inclined portion 142 on the first end part side in the axial direction of the cylindrical portion 72.

The fifth chamfered portion 143, including the inner surface 143a, has an arc shape with its center on the second end part side in the axial direction of the cylindrical portion 72 with respect to the inner surface 143a. The fifth chamfered portion 143 is a round chamfer. The fifth chamfered portion 143, including the inner surface 143a, is positioned toward the second end part side in the axial direction of the cylindrical portion 72 as it approaches the first inclined portion 141 from a center position in the circumferential direction of the cylindrical portion 72. The fifth chamfered portion 143, including the inner surface 143a, is positioned toward the second end part side in the axial direction of the cylindrical portion 72 as it approaches the second inclined portion 142 from the center position in the circumferential direction of the cylindrical portion 72.

The second circumferential edge portion 132, including an inner surface 132a that faces the space in the communication hole 91, extends in the circumferential direction of the cylindrical portion 72. The inner surface 132a of the second circumferential edge portion 132 also extends in the radial direction of the cylindrical portion 72 and is flat. The inner surface 132a has a planar shape extending perpendicular to the central axis of the cylindrical portion 72. The second circumferential edge portion 132 connects an end part of the second chamfered portion 113 on a side opposite to the first straight portion 111 and an end part of the fourth chamfered portion 123 on a side opposite to the second straight portion 121. The inner surface 132a of the second circumferential edge portion 132 connects an end part of the inner surface 113a of the second chamfered portion 113 on a side opposite to the inner surface 111a of the first straight portion 111 and an end part of the inner surface 123a of the fourth chamfered portion 123 on a side opposite to the inner surface 121a of the second straight portion 121.

As described above, the first circumferential edge portion 131 includes the first inclined portion 141 and the second inclined portion 142 as inclined portions which are formed to be inclined with respect to the axial direction of the cylindrical portion 72 and are a part of the edge 101 on the first end part side in the axial direction of the cylindrical portion 72. Further, the first circumferential edge portion 131 need only include an inclined portion formed to be inclined with respect to the axial direction of the cylindrical portion 72 and serving as at least a part of the edge 101 on the first end part side in the axial direction of the cylindrical portion 72. The first inclined portion 141 and the second inclined portion 142 are provided on the first end part side of the edge 101 in the axial direction of the cylindrical portion 72. The fifth chamfered portion 143 is provided at the first end part of the edge 101 in the axial direction of the cylindrical portion 72.

The edge 101 of the communication hole 91 is formed so that the first end part side in the axial direction of the cylindrical portion 72 is narrower than the second end part in the axial direction of the cylindrical portion 72.

The communication hole 91 has each corner that is round-chamfered, forming the first chamfered portion 112, the second chamfered portion 113, the third chamfered portion 122, the fourth chamfered portion 123, and the fifth chamfered portion 143.

The bumper cap 13 having the above-described shape is made of a synthetic resin or a metal. If the bumper cap 13 is formed of a synthetic resin material, it is formed by injection molding. If the bumper cap 13 is formed of a metal material, for example, an aluminum alloy material, it is formed by die casting.

In either case of injection molding or die casting, the bumper cap 13 is formed by pouring a molten material under a pressure into a cavity of a mold having a cavity that has a shape of the bumper cap 13. In either case of injection molding or die casting, a portion of the cavity of the bumper cap 13 that forms the through hole 81 of the lid portion 70 shown in FIG. 2 serves as an inlet for the material. For example, when the bumper cap 13 is injection molded, a plurality of (for example, six) inlets are provided at regular intervals in the circumferential direction at a portion of the lid portion 70 in which the inner circumferential edge portion 82 of the through hole 81 is formed. Then, when the material is caused to flow into the cavity from the inlets, the material flows through a space of the cavity forming the lid portion 70 to spread outward in the radial direction of the lid portion 70, and then flows through a space of the cavity forming the cylindrical portion 72 in the axial direction of the cylindrical portion 72 and in a direction away from the space forming the lid portion 70.

Here, a mold portion 200 shown in FIG. 4 for forming the communication hole 91 is formed in the mold. The mold portion 200 has the same shape as the space in the communication hole 91 shown in FIG. 3. As shown in FIG. 4, the mold portion 200 has an edge portion forming surface portion 201 for forming the edge 101 of the communication hole 91 shown in FIG. 3. The edge portion forming surface portion 201 has a first straight portion forming surface portion 211, a first chamfered portion forming surface portion 212, a second chamfered portion forming surface portion 213, a second straight portion forming surface portion 221, a third chamfered portion forming surface portion 222, and a fourth chamfered portion forming surface portion 223. Also, the edge portion forming surface portion 201 has a second circumferential edge portion forming surface portion 232, a first inclined portion forming surface portion 241, a second inclined portion forming surface portion 242, and a fifth chamfered portion forming surface portion 243.

The first straight portion forming surface portion 211 forms the inner surface 111a of the first straight portion 111 shown in FIG. 3. The first chamfered portion forming surface portion 212 forms the inner surface 112a of the first chamfered portion 112 shown in FIG. 3. The second chamfered portion forming surface portion 213 forms the inner surface 113a of the second chamfered portion 113 shown in FIG. 3. The second straight portion forming surface portion 221 forms the inner surface 121a of the second straight portion 121 shown in FIG. 3. The third chamfered portion forming surface portion 222 forms the inner surface 122a of the third chamfered portion 122 shown in FIG. 3. The fourth chamfered portion forming surface portion 223 forms the inner surface 123a of the fourth chamfered portion 123 shown in FIG. 3. The second circumferential edge portion forming surface portion 232 forms the inner surface 132a of the second circumferential edge portion 132 shown in FIG. 3. The first inclined portion forming surface portion 241 forms the inner surface 141a of the first inclined portion 141 shown in FIG. 3. The second inclined portion forming surface portion 242 forms the inner surface 142a of the second inclined portion 142 shown in FIG. 3. The fifth chamfered portion forming surface portion 243 forms the inner surface 143a of the fifth chamfered portion 143 shown in FIG. 3. An angle formed by the first inclined portion forming surface portion 241 and the second inclined portion forming surface portion 242 is an acute angle.

In either case of injection molding and die casting, as described above, the material flows through the space of the cavity forming the cylindrical portion 72 in the axial direction of the cylindrical portion 72 in a direction away from the space forming the lid portion 70 (see FIG. 2). That is, the material flows through the space of the cavity forming the cylindrical portion 72 in the axial direction of the cylindrical portion 72 from the second end part side toward the first end part side. Therefore, around the mold portion 200, as indicated by the two-dot chain line arrow in FIG. 4, the material flows from a side of the second circumferential edge portion forming surface portion 232 opposite to the fifth chamfered portion forming surface portion 243 to a side of the fifth chamfered portion forming surface portion 243 opposite to the second circumferential edge portion forming surface portion 232. Then, some of the material is guided in order of the second chamfered portion forming surface portion 213, the first straight portion forming surface portion 211, the first chamfered portion forming surface portion 212, the first inclined portion forming surface portion 241, and a part of the fifth chamfered portion forming surface portion 243 on the first inclined portion forming surface portion 241 side, and flows along these surface portions. Also, some of the material is guided in order of the fourth chamfered portion forming surface portion 223, the second straight portion forming surface portion 221, the third chamfered portion forming surface portion 222, the second inclined portion forming surface portion 242, and a part of the fifth chamfered portion forming surface portion 243 on the second inclined portion forming surface portion 242 side, and flows along these surface portions.

At that time, a distance between the first inclined portion forming surface portion 241 and the second inclined portion forming surface portion 242 becomes smaller on a downstream side than on an upstream side in a flow direction of the material. Thereby, the material flowing along the first inclined portion forming surface portion 241 and the material flowing along the second inclined portion forming surface portion 242 join smoothly at a large joining angle.

The edge 101 of the communication hole 91 shown in FIG. 3 is formed so that a portion on the fifth chamfered portion 143 side of the first circumferential edge portion 131 constituting the first end part positioned downstream is narrower than a portion on the second circumferential edge portion 132 side constituting the second end part positioned upstream through which the material flows in during molding. In other words, the communication hole 91 of the bumper cap 13 is formed so that the first end part side positioned downstream is narrower than the second end part positioned upstream through which the material flows in during molding. Also, the edge 101 of the communication hole 91 of the bumper cap 13 is formed so that the second circumferential edge portion 132, which is an upstream end part of the material that flows in during molding, is substantially perpendicular to the flow of the material. The communication hole 91 of the bumper cap 13 has a tapered shape in which the first end part positioned downstream in the flow direction of the material during molding becomes narrower toward the downstream side.

As shown in FIG. 2, the bumper cap 13 is attached to the cylinder 21 by covering the barrel portion 36 of the outer cylinder 32 of the cylinder 21 at an end part on a side from which the piston rod 50 extends in the axial direction of the barrel portion 36. At that time, the piston rod 50 is inserted through the through hole 81 of the lid portion 70.

In a state in which the bumper cap 13 is attached to the cylinder 21, as shown in FIG. 1, the cylindrical portion 72 covers a part of an outer circumferential surface 32a of the outer cylinder 32, which is an outer circumferential surface of the cylinder 21, from a radially outer side. Also, in this state, the lid portion 70 of the bumper cap 13 comes into contact with an axial end surface 32b of the outer cylinder 32, which is an axial end surface on a side opposite to the bottom portion 37 in the axial direction of the cylinder 21. Also, in this state, the cylindrical portion 72 is fixed to the outer cylinder 32 by coming into contact with and fitting onto the outer circumferential surface 32a of the outer cylinder 32 at the inner circumferential surface 72a thereof. The outer circumferential surface 32a of the outer cylinder 32 is an outer circumferential surface of the barrel portion 36.

Further, the cylindrical portion 72 of the bumper cap 13 may cover the entire outer circumferential surface 32a of the outer cylinder 32, which is the outer circumferential surface of the cylinder 21, from the radially outer side. That is, the cylindrical portion 72 of the bumper cap 13 may cover at least a part of the outer circumferential surface 32a of the outer cylinder 32, which is the outer circumferential surface of the cylinder 21, from the radially outer side.

Here, when the shock absorber 11 is assembled to the vehicle, one end part of a dust boot (not shown) that covers a portion of the piston rod 50 extending from the cylinder 21 is engaged with the flange portion 73 of the bumper cap 13. The communication hole 91 of the bumper cap 13 forms a flow path for allowing air to flow from a gap between the outer cylinder 32 of the cylinder 21 and the bumper cap 13 toward the outside of the bumper cap 13. Thereby, dust that has entered the gap between the outer cylinder 32 and the bumper cap 13 through, for example, the through hole 81 shown in FIG. 2 is discharged to the outside of the bumper cap 13 by a flow of air that flows from the through hole 81 to the outside through the gap between the outer cylinder 32 and the bumper cap 13, and then through the communication hole 91.

Patent Document 1 discloses a shock absorber in which a side of a cylinder from which a rod protrudes is covered with a bumper cap. In this shock absorber, the bumper cap has a cylindrical portion formed in a cylindrical shape and a top plate portion formed to close one end of the cylindrical portion, and an opening is formed in the cylindrical portion. Incidentally, in a shock absorber, it is desirable to improve durability of a bumper cap. For example, when the above-described opening is formed during molding of the bumper cap using a mold, if there is disturbance in a flow of a material flowing around a mold portion for forming the opening, surface defects are likely to occur on a surface around the opening. If such a surface defect occurs, there is a likelihood that a strength of the bumper cap will decrease and durability will be reduced.

In the shock absorber 11 of the first embodiment, the bumper cap 13 provided at the end part of the cylinder 21 on a side from which the piston rod 50 extends is formed by die casting or injection molding. The bumper cap 13 is formed such that the edge 101 of the communication hole 91, which is provided in the cylindrical portion 72 to allow communication between the inner surface 72a and the outer surface 72b of the cylindrical portion 72, is narrower on the first end part side positioned downstream than at the second end part positioned upstream through which the material flows in during molding. Therefore, the bumper cap 13 can increase the joining angle when the material flowing on both sides of the mold portion 200 forming the communication hole 91 joins on the downstream side, thereby allowing the material to join smoothly. Therefore, the bumper cap 13 can suppress a decrease in strength due to occurrence of weld lines which are surface defects that appear on a surface as grooves or patterns at a portion in which the material joins. Therefore, durability of the bumper cap 13 and the shock absorber 11 including the bumper cap 13 can be improved.

Also, the shock absorber 11 is formed so that the second circumferential edge portion 132 of the edge 101 of the communication hole 91 of the bumper cap 13, which is an upstream end part of the material that flows in during molding, is substantially perpendicular to the flow of the material. Thereby, a decrease in strength of the bumper cap 13 due to a shape of the second circumferential edge portion 132 can be suppressed. Therefore, the durability of the bumper cap 13 and the shock absorber 11 including the bumper cap 13 can be further improved.

Also, in the shock absorber 11, the corners of the edge 101 of the communication hole 91 of the bumper cap 13 are chamfered to form the first chamfered portion 112, the second chamfered portion 113, the third chamfered portion 122, the fourth chamfered portion 123, and the fifth chamfered portion 143. Therefore, the material is allowed to flow smoothly around the mold portion 200 forming the communication hole 91 of the bumper cap 13. Therefore, the durability of the bumper cap 13 and the shock absorber 11 including the bumper cap 13 can be further improved.

Also, since the bumper cap 13 of the shock absorber 11 is formed of a metal or a resin, the bumper cap 13 can be easily formed.

Also, the shock absorber 11 includes the first inclined portion 141 and the second inclined portion 142 which are formed so that at least a part of the first circumferential edge portion 131 of the edge 101 of the communication hole 91 of the bumper cap 13, which extends in the circumferential direction of the cylindrical portion 72, is inclined with respect to the axial direction of the cylindrical portion 72 to serve as an end part side of the edge 101 in the axial direction of the cylindrical portion 72. Therefore, when the material is caused to flow in the axial direction of the cylindrical portion 72, the bumper cap 13 can increase the joining angle when the material flowing on both sides of the mold portion 200, which forms the communication hole 91, in the circumferential direction of the cylindrical portion 72 joins on the first circumferential edge portion 131 side, thereby allowing the material to join smoothly. Therefore, the bumper cap 13 can suppress a decrease in strength due to occurrence of weld lines which are surface defects that appear on a surface as grooves or patterns at a portion in which the material joins. Therefore, the durability of the bumper cap 13 and the shock absorber 11 including the bumper cap 13 can be improved.

Also, in the shock absorber 11, the bumper cap 13 has the first axial edge portion 102 and the second axial edge portion 103 as axial edge portions extending in the axial direction of the cylindrical portion 72. Also, the bumper cap 13 includes the first inclined portion 141 formed to extend at an incline from one axial end of the first axial edge portion 102 and the second inclined portion 142 formed to extend at an incline from one axial end of the second axial edge portion 103 as inclined portions formed to be inclined with respect to the axial direction of the cylindrical portion 72. Therefore, the bumper cap 13 can reduce an angle difference between an angle formed by the first axial edge portion 102 and the first inclined portion 141 and an angle formed by the second axial edge portion 103 and the second inclined portion 142. Therefore, when the material is caused to flow in the axial direction of the cylindrical portion 72, the bumper cap 13 can reduce a difference in flow speed of the material flowing on both sides of the mold portion 200 forming the communication hole 91 in the circumferential direction of the cylindrical portion 72, thereby allowing the material to join more smoothly. Therefore, the durability of the bumper cap 13 and the shock absorber 11 including the bumper cap 13 can be further improved.

Also, in the bumper cap 13 of the shock absorber 11, the first inclined portion 141 and the second inclined portion 142 are provided on the first end part side in the axial direction of the cylindrical portion 72. Therefore, when the material is caused to flow in the axial direction of the cylindrical portion 72, the bumper cap 13 can increase the joining angle when the material flowing on both sides of the mold portion 200 forming the communication hole 91 in the circumferential direction of the cylindrical portion 72 to the first end part side joins, thereby allowing the material to join smoothly. Therefore, the durability of the bumper cap 13 and the shock absorber 11 including the bumper cap 13 can be improved.

Also, the bumper cap 13 of the shock absorber 11 is formed so that the first circumferential edge portion 131 of the first end part in the axial direction of the cylindrical portion 72 is formed at a more acute angle than the second circumferential edge portion 132 of the second end part in the axial direction of the cylindrical portion 72. Therefore, the bumper cap 13 can suppress occurrence of weld lines on the first end part side while suppressing a decrease in strength due to the shape of the second end part side.

Further, in the edge 101 of the communication hole 91 of the bumper cap 13, it is also possible to make a portion on the second end part side including the second circumferential edge portion 132 mirror-symmetrical to a portion on the first end part side including the first circumferential edge portion 131.

### Second Embodiment

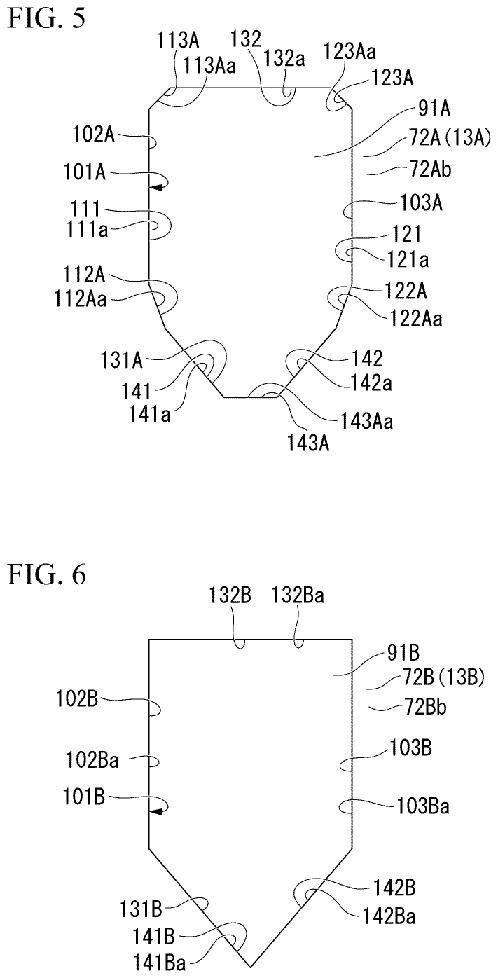

A second embodiment according to the present invention will be described mainly on the basis of FIG. 5, focusing on differences from the first embodiment. Further, parts common to those in the first embodiment will be denoted by the same terms and the same reference signs.

In the second embodiment, as shown in FIG. 5, a bumper cap 13A, which is partially different from the bumper cap 13 of the first embodiment, is used instead of the bumper cap 13. The bumper cap 13A has a cylindrical portion 72A, which is partially different from the cylindrical portion 72, instead of the cylindrical portion 72. The cylindrical portion 72A has a communication hole 91A, which is partially different from the communication hole 91, instead of the communication hole 91. The communication hole 91A allows communication between an outer circumferential surface 72Ab and an inner circumferential surface (not shown) of the cylindrical portion 72A.

An edge 101A of the communication hole 91A has a first axial edge portion 102A, which is partially different from the first axial edge portion 102, instead of the first axial edge portion 102. The edge 101A has a second axial edge portion 103A, which is partially different from the second axial edge portion 103, instead of the second axial edge portion 103. Here, also in the bumper cap 13A, a side opposite to the lid portion 70 (see FIG. 2) in an axial direction of the cylindrical portion 72A is referred to as a first end part side, and the lid portion 70 side in the axial direction of the cylindrical portion 72A is referred to as a second end part side. Also, in the communication hole 91A, an end part on a side opposite to the lid portion 70 in an axial direction of the cylindrical portion 72A is referred to as a first end part, and an end part on the lid portion 70 side in the axial direction of the cylindrical portion 72A is referred to as a second end part.

The first axial edge portion 102A has a first chamfered portion 112A instead of the first chamfered portion 112, and has a second chamfered portion 113A instead of the second chamfered portion 113.

The first chamfered portion 112A extends in a direction of the first end part from an end part of a first straight portion 111 on the first end part side in the axial direction of the cylindrical portion 72A. An inner surface 112Aa of the first chamfered portion 112A facing a space in the communication hole 91A extends in the direction of the first end part from an end part of an inner surface 111a of the first straight portion 111 on the first end part side in the axial direction of the cylindrical portion 72A. The first chamfered portion 112A is a flat chamfer in which the inner surface 112Aa is flat. The first chamfered portion 112A, including the inner surface 112Aa, approaches the second axial edge portion 103A in a circumferential direction of the cylindrical portion 72A as it is positioned further on the first end part side in the axial direction of the cylindrical portion 72A. The inner surface 112Aa of the first chamfered portion 112A also extends in a radial direction of the cylindrical portion 72A. An angle formed by the inner surface 112Aa and the inner surface 111a is an obtuse angle.

The second chamfered portion 113A extends in a direction of the second end part from an end part of the first straight portion 111 on the second end part side in the axial direction of the cylindrical portion 72A. An inner surface 113Aa of the second chamfered portion 113A facing the space in the communication hole 91A extends in the direction of the second end part from an end part of the inner surface 111a of the first straight portion 111 on the second end part side in the axial direction of the cylindrical portion 72A. The second chamfered portion 113A is a flat chamfer in which the inner surface 113Aa is flat. The second chamfered portion 113A, including the inner surface 113Aa, approaches the second axial edge portion 103A in the circumferential direction of the cylindrical portion 72A as it is positioned further on the second end part side in the axial direction of the cylindrical portion 72A. The inner surface 113Aa of the second chamfered portion 113A also extends in the radial direction of the cylindrical portion 72A. An angle formed by the inner surface 113Aa and the inner surface 111a is an obtuse angle and is smaller than an angle formed by the inner surface 112Aa and the inner surface 111a. The angle formed by the inner surface 113Aa and the inner surface 111a is equal to an angle formed by the inner surface 113Aa and an inner surface 132a of a second circumferential edge portion 132.

The second axial edge portion 103A has a third chamfered portion 122A instead of the third chamfered portion 122, and has a fourth chamfered portion 123A instead of the fourth chamfered portion 123.

The third chamfered portion 122A extends in the direction of the first end part from an end part of a second straight portion 121 on the first end part side in the axial direction of the cylindrical portion 72A. An inner surface 122Aa of the third chamfered portion 122A facing the space in the communication hole 91A extends in the direction of the first end part from an end part of the inner surface 121a of the second straight portion 121 on the first end part side in the axial direction of the cylindrical portion 72A. The third chamfered portion 122A is a flat chamfer in which the inner surface 122Aa is flat. The third chamfered portion 122A, including the inner surface 122Aa, approaches the first axial edge portion 102A in the circumferential direction of the cylindrical portion 72A as it is positioned further on the first end part side in the axial direction of the cylindrical portion 72A. The inner surface 122Aa of the third chamfered portion 122A also extends in the radial direction of the cylindrical portion 72A. The third chamfered portion 122A is aligned with the first chamfered portion 112A in position in the axial direction of the cylindrical portion 72A and is spaced apart from the first chamfered portion 112A in the circumferential direction of the cylindrical portion 72A to form a mirror symmetrical shape.

The fourth chamfered portion 123A extends in a direction of the second end part from an end part of the second straight portion 121 on the second end part side in the axial direction of the cylindrical portion 72A. An inner surface 123Aa of the fourth chamfered portion 123A facing the space in the communication hole 91A extends in the direction of the second end part from an end part of the inner surface 121a of the second straight portion 121 on the second end part side in the axial direction of the cylindrical portion 72A. The fourth chamfered portion 123A is a flat chamfer in which the inner surface 123Aa is flat. The fourth chamfered portion 123A, including the inner surface 123Aa, approaches the first axial edge portion 102A in the circumferential direction of the cylindrical portion 72A as it is positioned further on the second end part side in the axial direction of the cylindrical portion 72A. The inner surface 123Aa of the fourth chamfered portion 123A also extends in the radial direction of the cylindrical portion 72A. An angle formed by the inner surface 123Aa and the inner surface 121a is an obtuse angle and is smaller than an angle formed by the inner surface 122Aa and the inner surface 121a. The angle formed by the inner surface 123Aa and the inner surface 121a is equal to an angle formed by the inner surface 123Aa and the inner surface 132a of the second circumferential edge portion 132. The fourth chamfered portion 123A is aligned with the second chamfered portion 113A in position in the axial direction of the cylindrical portion 72A and is spaced apart from the second chamfered portion 113A in the circumferential direction of the cylindrical portion 72A to form a mirror symmetrical shape.

The edge 101A has a first circumferential edge portion 131A instead of the first circumferential edge portion 131. The first circumferential edge portion 131A has a mirror-symmetrical shape, and includes a fifth chamfered portion 143A instead of the fifth chamfered portion 143.

The fifth chamfered portion 143A connects one end of a first inclined portion 141 on the first end part side in the axial direction of the cylindrical portion 72A and one end of a second inclined portion 142 on the first end part side in the axial direction of the cylindrical portion 72A. An inner surface 143Aa of the fifth chamfered portion 143A facing the space in the communication hole 91A connects one end of an inner surface 141a of the first inclined portion 141 on the first end part side in the axial direction of the cylindrical portion 72A and one end of an inner surface 142a of the second inclined portion 142 on the first end part side in the axial direction of the cylindrical portion 72A.

The fifth chamfered portion 143A is a flat chamfer in which the inner surface 143Aa is flat. An angle that the inner surface 143Aa of the fifth chamfered portion 143A makes with the inner surface 141a of the first inclined portion 141 is equal to an angle that it makes with the inner surface 142a of the second inclined portion 142. An angle formed by the inner surface 112Aa and the inner surface 141a is equal to an angle formed by the inner surface 112Aa and the inner surface 111a. An angle formed by the inner surface 122Aa and the inner surface 142a is equal to an angle formed by the inner surface 122Aa and the inner surface 121a.

As described above, the first circumferential edge portion 131A includes the first inclined portion 141 and the second inclined portion 142 as inclined portions which are formed to be inclined with respect to the axial direction of the cylindrical portion 72A and are a part of the edge 101A on the first end part side in the axial direction of the cylindrical portion 72A. The fifth chamfered portion 143A is provided at the first end part of the edge 101A in the axial direction of the cylindrical portion 72A.

The edge 101A of the communication hole 91A is formed so that the first end part side in the axial direction of the cylindrical portion 72A is narrower than the second end part in the axial direction of the cylindrical portion 72A.

The communication hole 91A has each corner chamfered flat to form the first chamfered portion 112A, the second chamfered portion 113A, the third chamfered portion 122A, the fourth chamfered portion 123A, and the fifth chamfered portion 143A.

The bumper cap 13A having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13A serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72A in the axial direction of the cylindrical portion 72A and in a direction away from the space forming the lid portion 70. That is, the material flows through the space of the cavity forming the cylindrical portion 72A in the axial direction of the cylindrical portion 72A from the second end part side toward the first end part side.

The edge 101A of the communication hole 91A is formed so that a portion on the fifth chamfered portion 143A side of the first circumferential edge portion 131A constituting the first end part positioned downstream is narrower than a portion on the second circumferential edge portion 132 side constituting the second end part positioned upstream through which the material flows in during molding. In other words, the communication hole 91A of the bumper cap 13A is formed so that the first end part side positioned downstream is narrower than the second end part positioned upstream through which the material flows in during molding. Also, the edge 101A of the communication hole 91A of the bumper cap 13A is formed so that the second circumferential edge portion 132, which is an upstream end part of the material that flows in during molding, is substantially perpendicular to the flow of the material. The communication hole 91A of the bumper cap 13A has a tapered shape in which the first end part positioned downstream in a flow direction of the material during molding becomes narrower toward the downstream side.

The bumper cap 13A of the second embodiment is formed such that the edge 101A of the communication hole 91A provided in the cylindrical portion 72A is narrower on the first end part side positioned downstream than at the second end part positioned upstream through which the material flows in during molding. Therefore, the bumper cap 13A can increase a joining angle when the material flowing on both sides of a mold portion forming the communication hole 91A joins on the downstream side, thereby allowing the material to join smoothly. Therefore, the bumper cap 13A can suppress a decrease in strength due to occurrence of weld lines which are surface defects that appear on a surface as grooves or patterns at a portion in which the material joins. Therefore, durability of the bumper cap 13A can be improved.

Also, the corners of the edge 101A of the communication hole 91A of the bumper cap 13A are chamfered to form the first chamfered portion 112A, the second chamfered portion 113A, the third chamfered portion 122A, the fourth chamfered portion 123A, and the fifth chamfered portion 143A. Therefore, the material is allowed to flow smoothly around the mold portion forming the communication hole 91A of the bumper cap 13A. Therefore, the durability of the bumper cap 13A can be further improved.

Further, in the edge 101A of the communication hole 91A of the bumper cap 13A, it is also possible to make a portion on the second end part side including the second circumferential edge portion 132 mirror-symmetrical to a portion on the first end part side including the first circumferential edge portion 131A.

### Third Embodiment

A third embodiment according to the present invention will be described mainly on the basis of FIG. 6, focusing on differences from the first embodiment. Further, parts common to those in the first embodiment will be denoted by the same terms and the same reference signs.

In the third embodiment, as shown in FIG. 6, a bumper cap 13B, which is partially different from the bumper cap 13 of the first embodiment, is used instead of the bumper cap 13. The bumper cap 13B has a cylindrical portion 72B, which is partially different from the cylindrical portion 72, instead of the cylindrical portion 72. The cylindrical portion 72B has a communication hole 91B, which is partially different from the communication hole 91, instead of the communication hole 91. The communication hole 91B allows communication between an outer circumferential surface 72Bb and an inner circumferential surface (not shown) of the cylindrical portion 72B.

An edge 101B of the communication hole 91B has a first axial edge portion 102B, which is partially different from the first axial edge portion 102, instead of the first axial edge portion 102. The edge 101B has a second axial edge portion 103B, which is partially different from the second axial edge portion 103, instead of the second axial edge portion 103. Here, also in the bumper cap 13B, a side opposite to a lid portion 70 (see FIG. 2) in an axial direction of the cylindrical portion 72B is referred to as a first end part side, and the lid portion 70 side in the axial direction of the cylindrical portion 72B is referred to as a second end part side. Also, in the communication hole 91B, an end part on a side opposite to the lid portion 70 in the axial direction of the cylindrical portion 72B is referred to as a first end part, and an end part on the lid portion 70 side in the axial direction of the cylindrical portion 72B is referred to as a second end part.

The first axial edge portion 102B does not have the first chamfered portion 112 and the second chamfered portion 113. The first axial edge portion 102B has a shape in which the first straight portion 111 is elongated as is in the axial direction of the cylindrical portion 72B by an extent to which the first chamfered portion 112 and the second chamfered portion 113 are not provided. The first axial edge portion 102B has an inner surface 102Ba having a shape in which the inner surface 111a of the first straight portion 111 is elongated as is in the axial direction of the cylindrical portion 72B.

The second axial edge portion 103B does not have the third chamfered portion 122 and the fourth chamfered portion 123. The second axial edge portion 103B has a shape in which the second straight portion 121 is elongated as is in the axial direction of the cylindrical portion 72B by an extent to which the third chamfered portion 122 and the fourth chamfered portion 123 are not provided. The second axial edge portion 103B has an inner surface 103Ba having a shape in which the inner surface 121a of the second straight portion 121 is elongated as is in the axial direction of the cylindrical portion 72B.

The edge 101B has a first circumferential edge portion 131B instead of the first circumferential edge portion 131. The first circumferential edge portion 131B has a first inclined portion 141B instead of the first inclined portion 141, and has a second inclined portion 142B instead of the second inclined portion 142. The first circumferential edge portion 131B does not have the fifth chamfered portion 143.

The first inclined portion 141B has a shape in which the first inclined portion 141 is elongated as is in both the axial and circumferential directions of the cylindrical portion 72B by a combined extent to which the fifth chamfered portion 143 is not provided and the first chamfered portion 112 is not provided on the first axial edge portion 102B. The first inclined portion 141B has an inner surface 141Ba having a shape in which the inner surface 141a of the first inclined portion 141 is elongated as is in both the axial and circumferential directions of the cylindrical portion 72B.

The second inclined portion 142B has a shape in which the second inclined portion 142 is elongated as is in both the axial and circumferential directions of the cylindrical portion 72B by a combined extent to which the fifth chamfered portion 143 is not provided and the third chamfered portion 122 is not provided on the second axial edge portion 103B. The second inclined portion 142B has an inner surface 142Ba having a shape in which the inner surface 142a of the second inclined portion 142 is elongated as is in both the axial and circumferential directions of the cylindrical portion 72B. An end part of the first inclined portion 141B on the first end part side in the axial direction of the cylindrical portion 72B and an end part of the second inclined portion 142B on the first end part side in the axial direction of the cylindrical portion 72B are connected. An end part of the inner portion 141Ba on the first end part side in the axial direction of the cylindrical portion 72B and an end part of the inner portion 142Ba on the first end part side in the axial direction of the cylindrical portion 72B are connected.

The edge 101B has a second circumferential edge portion 132B instead of the second circumferential edge portion 132. The second circumferential edge portion 132B has a shape in which the second circumferential edge portion 132 is elongated as is in the circumferential direction of the cylindrical portion 72B by a combined extent to which the second chamfered portion 113 is not provided on the first axial edge portion 102B and the fourth chamfered portion 123 is not provided on the second axial edge portion 103B. The second circumferential edge portion 132B has an inner surface 132Ba having a shape in which the inner surface 132a of the second circumferential edge portion 132 is elongated as is in the circumferential direction of the cylindrical portion 72B.

As described above, the first circumferential edge portion 131B includes the first inclined portion 141B and the second inclined portion 142B as inclined portions formed to be inclined with respect to the axial direction of the cylindrical portion 72B and serving as the first end part of the edge 101B in the axial direction of the cylindrical portion 72B.

The edge 101B of the communication hole 91B is formed so that the first end part side in the axial direction of the cylindrical portion 72B is narrower than the second end part in the axial direction of the cylindrical portion 72B.

The bumper cap 13B having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13B serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72B in the axial direction of the cylindrical portion 72B and in a direction away from the space forming the lid portion 70. That is, the material flows through the space of the cavity forming the cylindrical portion 72B in the axial direction of the cylindrical portion 72B from the second end part side toward the first end part side.

The edge 101B of the communication hole 91B is formed so that a portion on the first circumferential edge portion 131B side constituting the first end part positioned downstream is narrower than a portion on the second circumferential edge portion 132B side constituting the second end part positioned upstream through which the material flows in during molding. In other words, the communication hole 91B of the bumper cap 13B is formed so that the first end part side positioned downstream is narrower than the second end part positioned upstream through which the material flows in during molding. Also, the edge 101B of the communication hole 91B of the bumper cap 13B is formed so that the second circumferential edge portion 132B, which is an upstream end part of the material that flows in during molding, is substantially perpendicular to the flow of the material. The communication hole 91B of the bumper cap 13B has a tapered shape in which the first end part positioned downstream in a flow direction of the material during molding becomes narrower toward the downstream side.

The bumper cap 13B of the third embodiment is formed such that the edge 101B of the communication hole 91B provided in the cylindrical portion 72B is narrower on the first end part side positioned downstream than at the second end part positioned upstream through which the material flows in during molding. Therefore, the bumper cap 13B can increase a joining angle when the material flowing on both sides of a mold portion forming the communication hole 91B joins on the downstream side, thereby allowing the material to join smoothly. Therefore, the bumper cap 13B can suppress a decrease in strength due to occurrence of weld lines which are surface defects that appear on a surface as grooves or patterns at a portion in which the material joins. Therefore, durability of the bumper cap 13B can be improved.

Further, in the edge 101B of the communication hole 91B of the bumper cap 13B, it is also possible to make a portion on the second end part side including the second circumferential edge portion 132B mirror-symmetrical to a portion on the first end part side including the first circumferential edge portion 131B.

### Fourth Embodiment

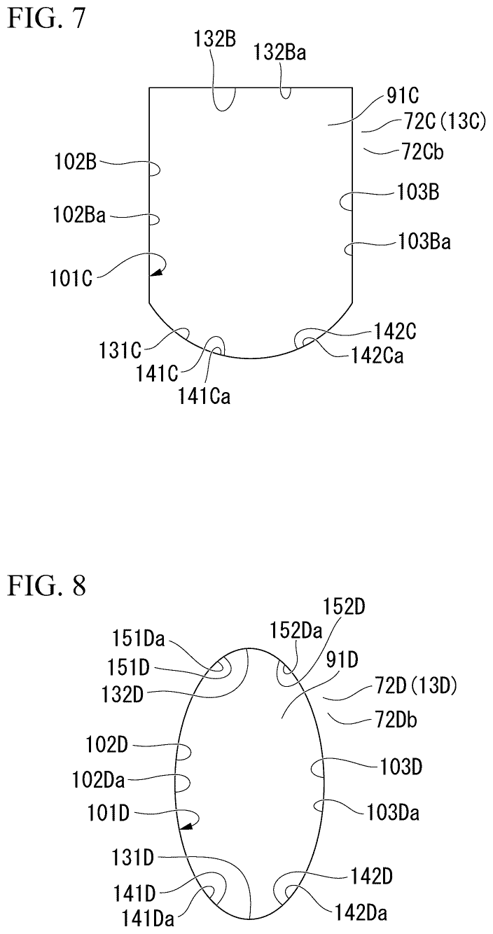

A fourth embodiment according to the present invention will be described mainly on the basis of FIG. 7, focusing on differences from the third embodiment. Further, parts common to those in the third embodiment will be denoted by the same terms and the same reference signs.

In the fourth embodiment, as shown in FIG. 7, a bumper cap 13C, which is partially different from the bumper cap 13B of the third embodiment, is used instead of the bumper cap 13B. The bumper cap 13C has a cylindrical portion 72C, which is partially different from the cylindrical portion 72B, instead of the cylindrical portion 72B. The cylindrical portion 72C has a communication hole 91C, which is partially different from the communication hole 91B, instead of the communication hole 91B. The communication hole 91C allows communication between an outer circumferential surface 72Cb and an inner circumferential surface (not shown) of the cylindrical portion 72C. Here, also in the bumper cap 13C, a side opposite to a lid portion 70 (see FIG. 2) in an axial direction of the cylindrical portion 72C is referred to as a first end part side, and the lid portion 70 side in the axial direction of the cylindrical portion 72C is referred to as a second end part side. Also, in the communication hole 91C, an end part on a side opposite to the lid portion 70 in the axial direction of the cylindrical portion 72C is referred to as a first end part, and an end part on the lid portion 70 side in the axial direction of the cylindrical portion 72C is referred to as a second end part.

An edge 101C of the communication hole 91C has a first circumferential edge portion 131C instead of the first circumferential edge portion 131B. The first circumferential edge portion 131C has a first inclined portion 141C instead of the first inclined portion 141B, and has a second inclined portion 142C instead of the second inclined portion 142B.

The first inclined portion 141C is formed to extend from one end of a first axial edge portion 102B on the first end part side in the axial direction of the cylindrical portion 72C to be inclined with respect to the first axial edge portion 102B. The first inclined portion 141C, including an inner surface 141Ca that faces a space in the communication hole 91C, has an arc shape. The first inclined portion 141C, including the inner surface 141Ca, has an arc shape with its center on the second end part side in the axial direction of the cylindrical portion 72C with respect to the inner surface 141Ca. The inner surface 141Ca of the first inclined portion 141C also extends in a radial direction of the cylindrical portion 72C and has a cylindrical surface shape.

The first inclined portion 141C extends in a direction of the first end part in the axial direction of the cylindrical portion 72C from one end of the first axial edge portion 102B on the first end part side in the axial direction of the cylindrical portion 72C. Moreover, the first inclined portion 141C approaches the second axial edge portion 103B in the circumferential direction of the cylindrical portion 72C as it is positioned further on the first end part side in the axial direction of the cylindrical portion 72C. The inner surface 141Ca of the first inclined portion 141C extends from one end of an inner surface 102Ba of the first axial edge portion 102B on the first end part side in the axial direction of the cylindrical portion 72C to the first end part side in the axial direction of the cylindrical portion 72C. Moreover, the inner surface 141Ca of the first inclined portion 141C approaches the second axial edge portion 103B in the circumferential direction of the cylindrical portion 72C as it is positioned further on the first end part side in the axial direction of the cylindrical portion 72C.

The second inclined portion 142C is formed to extend from one end of the second axial edge portion 103B on the first end part side in the axial direction of the cylindrical portion 72C to be inclined with respect to the second axial edge portion 103B. The second inclined portion 142C, including an inner surface 142Ca that faces the space in the communication hole 91C, has an arc shape. The second inclined portion 142C, including the inner surface 142Ca, has an arc shape with its center on the second end part side in the axial direction of the cylindrical portion 72C with respect to the inner surface 142Ca. The inner surface 142Ca of the second inclined portion 142C also extends in the radial direction of the cylindrical portion 72C and has a cylindrical surface shape.

The second inclined portion 142C extends in the direction of the first end part in the axial direction of the cylindrical portion 72C from one end of the second axial edge portion 103B on the first end part side in the axial direction of the cylindrical portion 72C. Moreover, the second inclined portion 142C approaches the first axial edge portion 102B in the circumferential direction of the cylindrical portion 72C as it is positioned further on the first end part side in the axial direction of the cylindrical portion 72C. The inner surface 142Ca of the second inclined portion 142C extends from one end of an inner surface 103Ba of the second axial edge portion 103B on the first end part side in the axial direction of the cylindrical portion 72C to the first end part side in the axial direction of the cylindrical portion 72C. Moreover, the inner surface 142Ca of the second inclined portion 142C approaches the first axial edge portion 102B in the circumferential direction of the cylindrical portion 72C as it is positioned further on the first end part side in the axial direction of the cylindrical portion 72C. The second inclined portion 142C is aligned with the first inclined portion 141C in position in the axial direction of the cylindrical portion 72C to form a mirror symmetrical shape. The inner surface 141Ca of the first inclined portion 141C and the inner surface 142Ca of the second inclined portion 142C are formed in the same continuous cylindrical surface shape.

As described above, the first circumferential edge portion 131C includes the first inclined portion 141C and the second inclined portion 142C as inclined portions formed to be inclined with respect to the axial direction of the cylindrical portion 72C and serving as the first end part of the edge 101C in the axial direction of the cylindrical portion 72C.

The edge 101C of the communication hole 91C is formed so that the first end part side in the axial direction of the cylindrical portion 72C is narrower than the second end part in the axial direction of the cylindrical portion 72C.

The bumper cap 13C having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13C serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72C in the axial direction of the cylindrical portion 72C and in a direction away from the space forming the lid portion 70. That is, the material flows through the space of the cavity forming the cylindrical portion 72C in the axial direction of the cylindrical portion 72C from the second end part side toward the first end part side.

The edge 101C of the communication hole 91C is formed so that a portion on the first circumferential edge portion 131C side constituting the first end part positioned downstream is narrower than a portion on a second circumferential edge portion 132B side constituting the second end part positioned upstream through which the material flows in during molding. In other words, the communication hole 91C of the bumper cap 13C is formed so that the first end part side positioned downstream is narrower than the second end part positioned upstream through which the material flows in during molding. Also, the edge 101C of the communication hole 91C of the bumper cap 13C is formed so that the second circumferential edge portion 132B, which is an upstream end part of the material that flows in during molding, is substantially perpendicular to the flow of the material. The communication hole 91C of the bumper cap 13C has a tapered shape in which the first end part positioned downstream in a flow direction of the material during molding becomes narrower toward the downstream side.

The bumper cap 13C of the fourth embodiment is formed such that the edge 101C of the communication hole 91C provided in the cylindrical portion 72C is narrower on the first end part side positioned downstream than at the second end part positioned upstream through which the material flows in during molding. Therefore, the bumper cap 13C can increase a joining angle when the material flowing on both sides of a mold portion forming the communication hole 91C joins on the downstream side, thereby allowing the material to join smoothly. Therefore, the bumper cap 13C can suppress a decrease in strength due to occurrence of weld lines which are surface defects that appear on a surface as grooves or patterns at a portion in which the material joins. Therefore, durability of the bumper cap 13C can be improved.

Further, in the edge 101C of the communication hole 91C of the bumper cap 13C, it is also possible to make a portion on the second end part side including the second circumferential edge portion 132B mirror-symmetrical to a portion on the first end part side including the first circumferential edge portion 131C.

### Fifth Embodiment

A fifth embodiment according to the present invention will be described mainly on the basis of FIG. 8, focusing on differences from the first embodiment. Further, parts common to those in the first embodiment will be denoted by the same terms and the same reference signs.

In the fifth embodiment, as shown in FIG. 8, a bumper cap 13D, which is partially different from the bumper cap 13 of the first embodiment, is used instead of the bumper cap 13. The bumper cap 13D has a cylindrical portion 72D, which is partially different from the cylindrical portion 72, instead of the cylindrical portion 72. The cylindrical portion 72D has a communication hole 91D, which is partially different from the communication hole 91, instead of the communication hole 91. The communication hole 91D allows communication between an outer circumferential surface 72Db and an inner circumferential surface (not shown) of the cylindrical portion 72D. Here, also in the bumper cap 13D, a side opposite to a lid portion 70 (see FIG. 2) in an axial direction of the cylindrical portion 72D is referred to as a first end part side, and the lid portion 70 side in the axial direction of the cylindrical portion 72D is referred to as a second end part side. Also, in the communication hole 91D, an end part on a side opposite to the lid portion 70 in the axial direction of the cylindrical portion 72D is referred to as a first end part, and an end part on the lid portion 70 side in the axial direction of the cylindrical portion 72D is referred to as a second end part.

An edge 101D of the communication hole 91D is formed in a closed loop shape.

The edge 101D has a first axial edge portion 102D and a second axial edge portion 103D as axial edge portions extending in the axial direction of the cylindrical portion 72D. The first axial edge portion 102D and the second axial edge portion 103D are aligned with each other in position in the axial direction of the cylindrical portion 72D and are spaced apart from each other in a circumferential direction of the cylindrical portion 72D to form a mirror symmetrical shape.

The first axial edge portion 102D, including an inner surface 102Da that faces a space in the communication hole 91D, extends in the axial direction of the cylindrical portion 72D. The first axial edge portion 102D, including the inner surface 102Da, has a curved shape with a center of a radius of curvature on the second axial edge portion 103D side in the circumferential direction of the cylindrical portion 72D. The inner surface 102Da of the first axial edge portion 102D also extends in a radial direction of the cylindrical portion 72D and has a curved shape.

The second axial edge portion 103D, including an inner surface 103Da that faces the space in the communication hole 91D, extends in the axial direction of the cylindrical portion 72D. The second axial edge portion 103D, including the inner surface 103Da, has a curved shape with a center of a radius of curvature on the first axial edge portion 102D side in the circumferential direction of the cylindrical portion 72D. The inner surface 103Da of the second axial edge portion 103D also extends in the radial direction of the cylindrical portion 72D and has a curved shape. The second axial edge portion 103D is aligned with the first axial edge portion 102D in position in the axial direction of the cylindrical portion 72D and is spaced apart from the first axial edge portion 102D in the circumferential direction of the cylindrical portion 72D to form a mirror symmetrical shape.

The edge 101D has a first circumferential edge portion 131D and a second circumferential edge portion 132D as circumferential edge portions extending in the circumferential direction of the cylindrical portion 72D. The edge 101D has the first circumferential edge portion 131D at an end part on the first end part side in the axial direction of the cylindrical portion 72D. The edge 101D has a second circumferential edge portion 132D at an end part on the second end part side in the axial direction of the cylindrical portion 72D. The first circumferential edge portion 131D and the second circumferential edge portion 132D are mirror symmetrical.

The first circumferential edge portion 131D has a mirror-symmetrical shape, and includes a first inclined portion 141D and a second inclined portion 142D.

The first inclined portion 141D is formed to extend from one end of the first axial edge portion 102D on the first end part side in the axial direction of the cylindrical portion 72D to be inclined with respect to the first axial edge portion 102D. The first inclined portion 141D, including an inner surface 141Da that faces the space in the communication hole 91D, has a curved shape with a center of a radius of curvature on the second axial edge portion 103D side in the circumferential direction of the cylindrical portion 72D. The inner surface 141Da of the first inclined portion 141D also extends in the radial direction of the cylindrical portion 72D and has a curved shape.

The first inclined portion 141D extends in a direction of the first end part in the axial direction of the cylindrical portion 72D from one end of the first axial edge portion 102D on the first end part side in the axial direction of the cylindrical portion 72D. Moreover, the first inclined portion 141D approaches the second axial edge portion 103D in the circumferential direction of the cylindrical portion 72D as it is positioned further on the first end part side in the axial direction of the cylindrical portion 72D. The inner surface 141Da of the first inclined portion 141D extends from one end of the inner surface 102Da of the first axial edge portion 102D on the first end part side in the axial direction of the cylindrical portion 72D to the first end part side in the axial direction of the cylindrical portion 72D. Moreover, the inner surface 141Da of the first inclined portion 141D approaches the second axial edge portion 103D in the circumferential direction of the cylindrical portion 72D as it is positioned further on the first end part side in the axial direction of the cylindrical portion 72D.

The second inclined portion 142D is formed to extend from one end of the second axial edge portion 103D on the first end part side in the axial direction of the cylindrical portion 72D to be inclined with respect to the second axial edge portion 103D. The second inclined portion 142D, including an inner surface 142Da that faces the space in the communication hole 91D, has a curved shape with a center of a radius of curvature on the first axial edge portion 102D side in the circumferential direction of the cylindrical portion 72D. The inner surface 142Da of the second inclined portion 142D also extends in the radial direction of the cylindrical portion 72D and has a curved shape.

The second inclined portion 142D extends in the direction of the first end part in the axial direction of the cylindrical portion 72D from one end of the second axial edge portion 103D on the first end part side in the axial direction of the cylindrical portion 72D. Moreover, the second inclined portion 142D approaches the first axial edge portion 102D in the circumferential direction of the cylindrical portion 72D as it is positioned further on the first end part side in the axial direction of the cylindrical portion 72D. The inner surface 142Da of the second inclined portion 142D extends from one end of the inner surface 103Da of the second axial edge portion 103D on the first end part side in the axial direction of the cylindrical portion 72D to the first end part side in the axial direction of the cylindrical portion 72D. Moreover, the inner surface 142Da of the second inclined portion 142D approaches the first axial edge portion 102D in the circumferential direction of the cylindrical portion 72D as it is positioned further on the first end part side in the axial direction of the cylindrical portion 72D. The second inclined portion 142D is aligned with the first inclined portion 141D in position in the axial direction of the cylindrical portion 72D to form a mirror symmetrical shape.

The second circumferential edge portion 132D has a mirror-symmetrical shape, and includes a third inclined portion 151D and a fourth inclined portion 152D.

The third inclined portion 151D is formed to extend from one end of the first axial edge portion 102D on the second end part side in the axial direction of the cylindrical portion 72D to be inclined with respect to the first axial edge portion 102D. The third inclined portion 151D, including an inner surface 151Da that faces the space in the communication hole 91D, has a curved shape with a center of a radius of curvature on the second axial edge portion 103D side in the circumferential direction of the cylindrical portion 72D. The inner surface 151Da of the third inclined portion 151D also extends in the radial direction of the cylindrical portion 72D and has a curved shape.

The third inclined portion 151D extends in a direction of the second end part in the axial direction of the cylindrical portion 72D from one end of the first axial edge portion 102D on the second end part side in the axial direction of the cylindrical portion 72D. Moreover, the third inclined portion 151D approaches the second axial edge portion 103D in the circumferential direction of the cylindrical portion 72D as it is positioned further on the second end part side in the axial direction of the cylindrical portion 72D. The inner surface 151Da of the third inclined portion 151D extends from one end of the inner surface 102Da of the first axial edge portion 102D on the second end part side in the axial direction of the cylindrical portion 72D to the second end part side in the axial direction of the cylindrical portion 72D. Moreover, the inner surface 151Da of the third inclined portion 151D approaches the second axial edge portion 103D in the circumferential direction of the cylindrical portion 72D as it is positioned further on the second end part side in the axial direction of the cylindrical portion 72D.

The fourth inclined portion 152D is formed to extend from one end of the second axial edge portion 103D on the second end part side in the axial direction of the cylindrical portion 72D to be inclined with respect to the second axial edge portion 103D. The fourth inclined portion 152D, including an inner surface 152Da that faces the space in the communication hole 91D, has a curved shape with a center of a radius of curvature on the first axial edge portion 102D side in the circumferential direction of the cylindrical portion 72D. The inner surface 152Da of the fourth inclined portion 152D also extends in the radial direction of the cylindrical portion 72D and has a curved shape.

The fourth inclined portion 152D extends in the direction of the second end part in the axial direction of the cylindrical portion 72D from one end of the second axial edge portion 103D on the second end part side in the axial direction of the cylindrical portion 72D. Moreover, the fourth inclined portion 152D approaches the first axial edge portion 102D in the circumferential direction of the cylindrical portion 72D as it is positioned further on the second end part side in the axial direction of the cylindrical portion 72D. The inner surface 152Da of the fourth inclined portion 152D extends from one end of the inner surface 103Da of the second axial edge portion 103D on the second end part side in the axial direction of the cylindrical portion 72D to the second end part side in the axial direction of the cylindrical portion 72D. Moreover, the inner surface 152Da of the fourth inclined portion 152D approaches the first axial edge portion 102D in the circumferential direction of the cylindrical portion 72D as it is positioned further on the second end part side in the axial direction of the cylindrical portion 72D. The fourth inclined portion 152D is aligned with the third inclined portion 151D in position in the axial direction of the cylindrical portion 72D to form a mirror symmetrical shape.

The first axial edge portion 102D, the second axial edge portion 103D, the first inclined portion 141D, the second inclined portion 142D, the third inclined portion 151D, and the fourth inclined portion 152D are formed in the same continuous elliptical shape. The inner surface 102Da, the inner surface 103Da, the inner surface 141Da, the inner surface 142Da, the inner surface 151Da, and the inner surface 152Da are formed in the same continuous elliptical shape.

As described above, the first circumferential edge portion 131D includes the first inclined portion 141D and the second inclined portion 142D as inclined portions formed to be inclined with respect to the axial direction of the cylindrical portion 72D and serving as the first end part of the edge 101D in the axial direction of the cylindrical portion 72D. The second circumferential edge portion 132D includes the third inclined portion 151D and the fourth inclined portion 152D as inclined portions formed to be inclined with respect to the axial direction of the cylindrical portion 72D and serving as the second end part of the edge 101D in the axial direction of the cylindrical portion 72D.

The bumper cap 13D having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13D serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72D in the axial direction of the cylindrical portion 72D and in a direction away from the space forming the lid portion 70. That is, the material flows through the space of the cavity forming the cylindrical portion 72D in the axial direction of the cylindrical portion 72D from the second end part side toward the first end part side.

In the bumper cap 13D of the fifth embodiment, the first circumferential edge portion 131D of the edge 101D of the communication hole 91D extending in the circumferential direction of the cylindrical portion 72D includes the first inclined portion 141D and the second inclined portion 142D formed to be inclined with respect to the axial direction of the cylindrical portion 72D and serving as an end part of the edge 101D in the axial direction of the cylindrical portion 72D. Therefore, when the material is caused to flow in the axial direction of the cylindrical portion 72D, the bumper cap 13D can increase a joining angle when the material flowing on both sides of a mold portion, which forms the communication hole 91D, in the circumferential direction of the cylindrical portion 72D joins on the first circumferential edge portion 131D side, thereby allowing the material to join smoothly. Therefore, the bumper cap 13D can suppress a decrease in strength due to occurrence of weld lines which are surface defects that appear on a surface as grooves or patterns at a portion in which the material joins. Therefore, durability of the bumper cap 13D can be improved.

Also, the bumper cap 13D has the first axial edge portion 102D and the second axial edge portion 103D as axial edge portions extending in the axial direction of the cylindrical portion 72D. Also, the bumper cap 13D includes the first inclined portion 141D formed to extend at an incline from one axial end of the first axial edge portion 102D and the second inclined portion 142D formed to extend at an incline from one axial end of the second axial edge portion 103D as inclined portions formed to be inclined with respect to the axial direction of the cylindrical portion 72D. Therefore, the bumper cap 13D can reduce an angle difference between an angle formed by the first axial edge portion 102D and the first inclined portion 141D and an angle formed by the second axial edge portion 103D and the second inclined portion 142D. Therefore, when the material is caused to flow in the axial direction of the cylindrical portion 72D, the bumper cap 13D can reduce a difference in flow speed of the material flowing on both sides of the mold portion forming the communication hole 91D in the circumferential direction of the cylindrical portion 72D, thereby allowing the material to join more smoothly. Therefore, the durability of the bumper cap 13D can be further improved.

Also, in the bumper cap 13D, the first inclined portion 141D and the second inclined portion 142D are provided at the first end part in the axial direction of the cylindrical portion 72D. Therefore, when the material is caused to flow in the axial direction of the cylindrical portion 72D, the bumper cap 13D can increase the joining angle when the material flowing on both sides of the mold portion forming the communication hole 91D in the circumferential direction of the cylindrical portion 72D to the first end part side joins, thereby allowing the material to join smoothly. Therefore, the durability of the bumper cap 13D can be improved.

Also, in the bumper cap 13D, the first inclined portion 141D and the second inclined portion 142D are provided on the first end part side in the axial direction of the cylindrical portion 72D, and the third inclined portion 151D and the fourth inclined portion 152D are provided on the second end part side in the axial direction of the cylindrical portion 72D. Moreover, in the bumper cap 13D, the first inclined portion 141D and the second inclined portion 142D are symmetrically formed with respect to the third inclined portion 151D and the fourth inclined portion 152D. Therefore, the bumper cap 13D allows the material to flow smoothly around the mold portion forming the communication hole 91D. Therefore, the durability of the bumper cap 13D can be improved.

### Sixth Embodiment

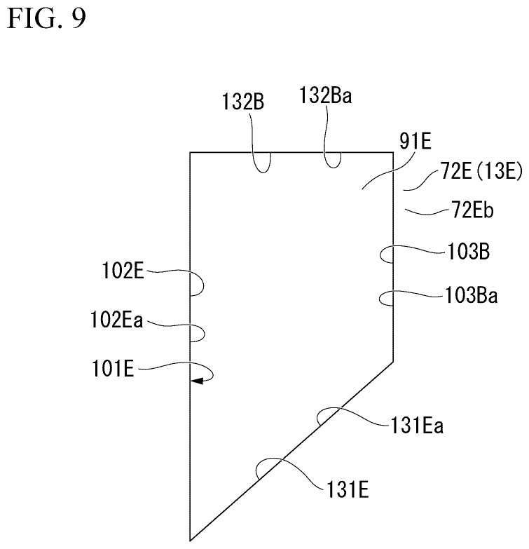

A sixth embodiment according to the present invention will be described mainly on the basis of FIG. 9, focusing on differences from the third embodiment. Further, parts common to those in the third embodiment will be denoted by the same terms and the same reference signs.

In the sixth embodiment, as shown in FIG. 9, a bumper cap 13E, which is partially different from the bumper cap 13B of the third embodiment, is used instead of the bumper cap 13B. The bumper cap 13E has a cylindrical portion 72E, which is partially different from the cylindrical portion 72B, instead of the cylindrical portion 72B. The cylindrical portion 72E has a communication hole 91E, which is partially different from the communication hole 91B, instead of the communication hole 91B. The communication hole 91E allows communication between an outer circumferential surface 72Eb and an inner circumferential surface (not shown) of the cylindrical portion 72E. Here, also in the bumper cap 13E, a side opposite to a lid portion 70 (see FIG. 2) in an axial direction of the cylindrical portion 72E is referred to as a first end part side, and the lid portion 70 side in the axial direction of the cylindrical portion 72E is referred to as a second end part side. Also, in the communication hole 91E, an end part on a side opposite to the lid portion 70 in the axial direction of the cylindrical portion 72E is referred to as a first end part, and an end part on the lid portion 70 side in the axial direction of the cylindrical portion 72E is referred to as a second end part.

An edge 101E of the communication hole 91E has a first axial edge portion 102E which is partially different from the first axial edge portion 102B. The first axial edge portion 102E is different from the first axial edge portion 102B in that a length in an axial direction of the cylindrical portion 72E is larger than that of the first axial edge portion 102B. An inner surface 102Ea of the first axial edge portion 102E facing a space in the communication hole 91E also differs from the inner surface 102Ba of the first axial edge portion 102B in that a length in the axial direction of the cylindrical portion 72E is larger than that of the inner surface 102Ba.

The edge 101E of the communication hole 91E has a first circumferential edge portion 131E (inclined portion) instead of the first circumferential edge portion 131B. The first circumferential edge portion 131E is formed to extend from one end of a second axial edge portion 103B on the first end part side in the axial direction of the cylindrical portion 72E to be inclined with respect to the second axial edge portion 103B. An end part of the first circumferential edge portion 131E on a side opposite to the second axial edge portion 103B is connected to one end of the first axial edge portion 102E on the first end part side in the axial direction of the cylindrical portion 72E. The first circumferential edge portion 131E, including an inner surface 131Ea that faces the space in the communication hole 91E, is linear. The inner surface 131Ea also extends in a radial direction of the cylindrical portion 72E and is flat.

The first circumferential edge portion 131E extends in a direction of the first end part in the axial direction of the cylindrical portion 72E from one end of the second axial edge portion 103B on the first end part side in the axial direction of the cylindrical portion 72E. Moreover, the first circumferential edge portion 131E approaches the first axial edge portion 102E in a circumferential direction of the cylindrical portion 72E as it is positioned further on the first end part side in the axial direction of the cylindrical portion 72E. The inner surface 131Ea of the first circumferential edge portion 131E extends from one end of an inner surface 103Ba of the second axial edge portion 103B on the first end part side in the axial direction of the cylindrical portion 72E to the first end part side in the axial direction of the cylindrical portion 72E. Moreover, the inner surface 131Ea of the first circumferential edge portion 131E approaches the first axial edge portion 102E in the circumferential direction of the cylindrical portion 72E to be connected to the inner surface 102Ea as it is positioned further on the first end part side in the axial direction of the cylindrical portion 72E.

As described above, the first circumferential edge portion 131E is an inclined portion formed to be inclined with respect to the axial direction of the cylindrical portion 72E and serving as the first end part side of the edge 101E in the axial direction of the cylindrical portion 72E.

The edge 101E of the communication hole 91E is formed so that the first end part side in the axial direction of the cylindrical portion 72E is narrower than the second end part in the axial direction of the cylindrical portion 72E.

The bumper cap 13E having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13E serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72E in the axial direction of the cylindrical portion 72E and in a direction away from the space forming the lid portion 70. That is, the material flows through the space of the cavity forming the cylindrical portion 72E in the axial direction of the cylindrical portion 72E from the second end part side toward the first end part side.

The edge 101E of the communication hole 91E is formed so that a portion on the first circumferential edge portion 131E side constituting the first end part positioned downstream is narrower than a portion on a second circumferential edge portion 132B side constituting the second end part positioned upstream through which the material flows in during molding. In other words, the communication hole 91E of the bumper cap 13E is formed so that the first end part side positioned downstream is narrower than the second end part positioned upstream through which the material flows in during molding. Also, the edge 101E of the communication hole 91E of the bumper cap 13E is formed so that the second circumferential edge portion 132B, which is an upstream end part of the material that flows in during molding, is substantially perpendicular to the flow of the material. The communication hole 91E of the bumper cap 13E has a tapered shape in which the first end part positioned downstream in a flow direction of the material during molding becomes narrower toward the downstream side.

The bumper cap 13E of the sixth embodiment is formed such that the edge 101E of the communication hole 91E provided in the cylindrical portion 72E is narrower on the first end part side positioned downstream than at the second end part positioned upstream through which the material flows in during molding. Therefore, the bumper cap 13E can increase a joining angle when the material flowing on both sides of a mold portion forming the communication hole 91E joins on the downstream side, thereby allowing the material to join smoothly. Therefore, the bumper cap 13E can suppress a decrease in strength due to occurrence of weld lines which are surface defects that appear on a surface as grooves or patterns at a portion in which the material joins. Therefore, durability of the bumper cap 13E can be improved.

Further, in the edge 101E of the communication hole 91E of the bumper cap 13E, it is also possible to make a portion on the second end part side including the second circumferential edge portion 132B mirror-symmetrical or point-symmetrical to a portion on the first end part side including the first circumferential edge portion 131E.

### Seventh Embodiment

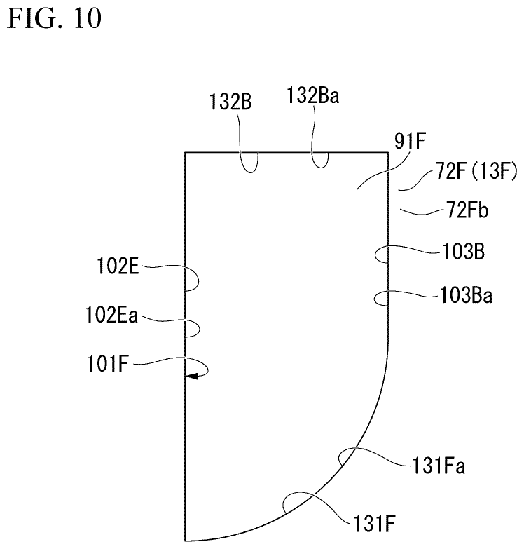

A seventh embodiment according to the present invention will be described mainly on the basis of FIG. 10, focusing on differences from the sixth embodiment. Further, parts common to those in the sixth embodiment will be denoted by the same terms and the same reference signs.

In the seventh embodiment, as shown in FIG. 10, a bumper cap 13F, which is partially different from the bumper cap 13E of the sixth embodiment, is used instead of the bumper cap 13E. The bumper cap 13F has a cylindrical portion 72F, which is partially different from the cylindrical portion 72E, instead of the cylindrical portion 72E. The cylindrical portion 72F has a communication hole 91F, which is partially different from the communication hole 91E, instead of the communication hole 91E. The communication hole 91F allows communication between an outer circumferential surface 72Fb and an inner circumferential surface (not shown) of the cylindrical portion 72F. Here, also in the bumper cap 13F, a side opposite to a lid portion 70 (see FIG. 2) in an axial direction of the cylindrical portion 72F is referred to as a first end part side, and the lid portion 70 side in the axial direction of the cylindrical portion 72F is referred to as a second end part side. Also, in the communication hole 91F, an end part on a side opposite to the lid portion 70 in the axial direction of the cylindrical portion 72F is referred to as a first end part, and an end part on the lid portion 70 side in the axial direction of the cylindrical portion 72F is referred to as a second end part.

An edge 101F of the communication hole 91F has a first circumferential edge portion 131F (inclined portion) instead of the first circumferential edge portion 131E. The first circumferential edge portion 131F is formed to extend from one end of a second axial edge portion 103B on the first end part side in the axial direction of the cylindrical portion 72F to be inclined with respect to the second axial edge portion 103B. An end part of the first circumferential edge portion 131F on a side opposite to the second axial edge portion 103B is connected to one end of a first axial edge portion 102E on the first end part side in the axial direction of the cylindrical portion 72F. The first circumferential edge portion 131F, including an inner surface 131Fa that faces a space in the communication hole 91F, has an arc shape. The inner surface 131Fa also extends in a radial direction of the cylindrical portion 72F and has a cylindrical surface shape.

The first circumferential edge portion 131F extends in a direction of the first end part in the axial direction of the cylindrical portion 72F from one end of the second axial edge portion 103B on the first end part side in the axial direction of the cylindrical portion 72F. Moreover, the first circumferential edge portion 131F approaches the first axial edge portion 102E in a circumferential direction of the cylindrical portion 72F as it is positioned further on the first end part side in the axial direction of the cylindrical portion 72F. The inner surface 131Fa of the first circumferential edge portion 131F extends from one end of an inner surface 103Ba of the second axial edge portion 103B on the first end part side in the axial direction of the cylindrical portion 72F to the first end part side in the axial direction of the cylindrical portion 72F. Moreover, the inner surface 131Fa of the first circumferential edge portion 131F approaches the first axial edge portion 102E in the circumferential direction of the cylindrical portion 72F to be connected to an inner surface 102Ea as it is positioned further on the first end part side in the axial direction of the cylindrical portion 72F.

As described above, the first circumferential edge portion 131F is an inclined portion formed to be inclined with respect to the axial direction of the cylindrical portion 72F and serving as the first end part side of the edge 101F in the axial direction of the cylindrical portion 72F.

The edge 101F of the communication hole 91F is formed so that the first end part side in the axial direction of the cylindrical portion 72F is narrower than the second end part in the axial direction of the cylindrical portion 72F.

The bumper cap 13F having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13F serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72F in the axial direction of the cylindrical portion 72F and in a direction away from the space forming the lid portion 70. That is, the material flows through the space of the cavity forming the cylindrical portion 72F in the axial direction of the cylindrical portion 72F from the second end part side toward the first end part side.

The edge 101F of the communication hole 91F is formed so that a portion on the first circumferential edge portion 131F side constituting the first end part positioned downstream is narrower than a portion on a second circumferential edge portion 132B side constituting the second end part positioned upstream through which the material flows in during molding. In other words, the communication hole 91F of the bumper cap 13F is formed so that the first end part side positioned downstream is narrower than the second end part positioned upstream through which the material flows in during molding. Also, the edge 101F of the communication hole 91F of the bumper cap 13F is formed so that the second circumferential edge portion 132B, which is an upstream end part of the material that flows in during molding, is substantially perpendicular to the flow of the material. The communication hole 91F of the bumper cap 13F has a tapered shape in which the first end part positioned downstream in a flow direction of the material during molding becomes narrower toward the downstream side.

The bumper cap 13F of the seventh embodiment is formed such that the edge 101F of the communication hole 91F provided in the cylindrical portion 72F is narrower on the first end part side positioned downstream than at the second end part positioned upstream through which the material flows in during molding. Therefore, the bumper cap 13F can increase a joining angle when the material flowing on both sides of a mold portion forming the communication hole 91F joins on the downstream side, thereby allowing the material to join smoothly. Therefore, the bumper cap 13F can suppress a decrease in strength due to occurrence of weld lines which are surface defects that appear on a surface as grooves or patterns at a portion in which the material joins. Therefore, durability of the bumper cap 13F can be improved.

In addition, in the edge 101F of the communication hole 91F of the bumper cap 13F, it is also possible to make a portion on the second end part side including the second circumferential edge portion 132B mirror-symmetrical or point-symmetrical to a portion on the first end part side including the first circumferential edge portion 131F.

### Eighth Embodiment

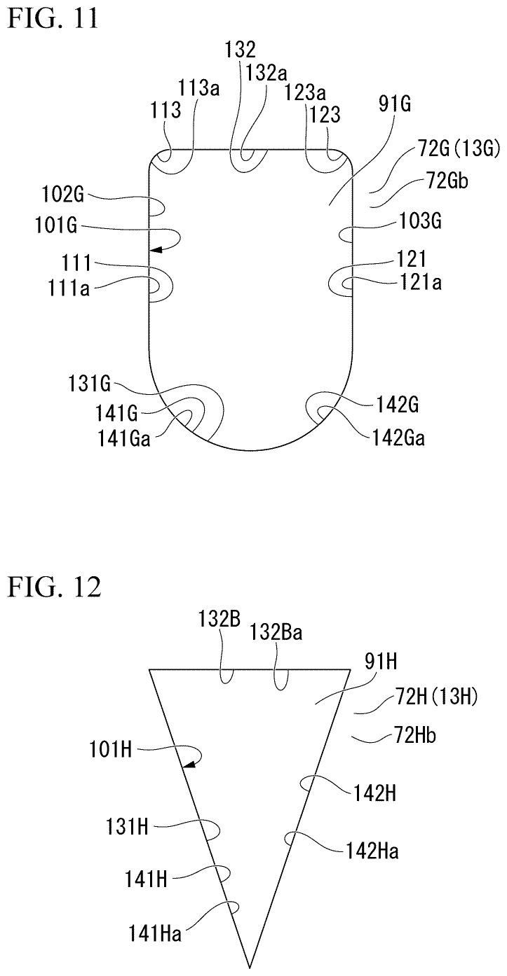

An eighth embodiment according to the present invention will be described mainly on the basis of FIG. 11, focusing on differences from the first embodiment. Further, parts common to those in the first embodiment will be denoted by the same terms and the same reference signs.

In the eighth embodiment, as shown in FIG. 11, a bumper cap 13G, which is partially different from the bumper cap 13 of the first embodiment, is used instead of the bumper cap 13. The bumper cap 13G has a cylindrical portion 72G, which is partially different from the cylindrical portion 72, instead of the cylindrical portion 72. The cylindrical portion 72G has a communication hole 91G, which is partially different from the communication hole 91, instead of the communication hole 91. The communication hole 91G allows communication between an outer circumferential surface 72Gb and an inner circumferential surface (not shown) of the cylindrical portion 72G.

An edge 101G of the communication hole 91G has a first axial edge portion 102G, which is partially different from the first axial edge portion 102, instead of the first axial edge portion 102. The edge 101G has a second axial edge portion 103G, which is partially different from the second axial edge portion 103, instead of the second axial edge portion 103. Here, also in the bumper cap 13G, a side opposite to a lid portion 70 (see FIG. 2) in an axial direction of the cylindrical portion 72G is referred to as a first end part side, and the lid portion 70 side in the axial direction of the cylindrical portion 72G is referred to as a second end part side. Also, in the communication hole 91G, an end part on a side opposite to the lid portion 70 in the axial direction of the cylindrical portion 72G is referred to as a first end part, and an end part on the lid portion 70 side in the axial direction of the cylindrical portion 72G is referred to as a second end part.

The first axial edge portion 102G does not have the first chamfered portion 112. The second axial edge portion 103G does not have the third chamfered portion 122.

The edge 101B has a first circumferential edge portion 131G instead of the first circumferential edge portion 131. The first circumferential edge portion 131G has a first inclined portion 141G instead of the first inclined portion 141, and has a second inclined portion 142G instead of the second inclined portion 142. The first circumferential edge portion 131G does not have the fifth chamfered portion 143.

The first inclined portion 141G is formed to extend from one end of the first axial edge portion 102G on the first end part side in the axial direction of the cylindrical portion 72G to be inclined with respect to a first straight portion 111 of the first axial edge portion 102G. The first inclined portion 141G, including an inner surface 141Ga that faces a space in the communication hole 91G, has an arc shape. The first inclined portion 141G, including the inner surface 141Ga, has an arc shape with its center on the second end part side in the axial direction of the cylindrical portion 72G with respect to the inner surface 141Ga. The inner surface 141Ga of the first inclined portion 141G also extends in a radial direction of the cylindrical portion 72G and has a cylindrical surface shape.

The first inclined portion 141G extends in a direction of the first end part in the axial direction of the cylindrical portion 72G from one end of the first axial edge portion 102G on the first end part side in the axial direction of the cylindrical portion 72G. Moreover, the first inclined portion 141G approaches the second axial edge portion 103G in a circumferential direction of the cylindrical portion 72G as it is positioned further on the first end part side in the axial direction of the cylindrical portion 72G. The inner surface 141Ga of the first inclined portion 141G extends from one end of an inner surface 111a of the first straight portion 111 on the first end part side in the axial direction of the cylindrical portion 72G to the first end part side in the axial direction of the cylindrical portion 72G. Moreover, the inner surface 141Ga of the first inclined portion 141G approaches the second axial edge portion 103G in the circumferential direction of the cylindrical portion 72G as it is positioned further on the first end part side in the axial direction of the cylindrical portion 72G.

The second inclined portion 142G is formed to extend from one end of the second axial edge portion 103G on the first end part side in the axial direction of the cylindrical portion 72G to be inclined with respect to a second straight portion 121 of the second axial edge portion 103G. The second inclined portion 142G, including an inner surface 142Ga that faces the space in the communication hole 91G, has an arc shape. The second inclined portion 142G, including the inner surface 142Ga, has an arc shape with its center on the second end part side in the axial direction of the cylindrical portion 72G with respect to the inner surface 142Ga. The inner surface 142Ga of the second inclined portion 142G also extends in the radial direction of the cylindrical portion 72G and has a cylindrical surface shape.

The second inclined portion 142G extends in the direction of the first end part in the axial direction of the cylindrical portion 72G from one end of the second axial edge portion 103G on the first end part side in the axial direction of the cylindrical portion 72G. Moreover, the second inclined portion 142G approaches the first axial edge portion 102G in the circumferential direction of the cylindrical portion 72G as it is positioned further on the first end part side in the axial direction of the cylindrical portion 72G. The inner surface 142Ga of the second inclined portion 142G extends in the direction of the first end part side in the axial direction of the cylindrical portion 72G from one end of the inner surface 121a of the second straight portion 121 of the second axial edge portion 103G on the first end part side in the axial direction of the cylindrical portion 72G. Moreover, the inner surface 142Ga of the second inclined portion 142G approaches the first axial edge portion 102G in the circumferential direction of the cylindrical portion 72G as it is positioned further on the first end part side in the axial direction of the cylindrical portion 72G. The second inclined portion 142G is aligned with the first inclined portion 141G in position in the axial direction of the cylindrical portion 72G to form a mirror symmetrical shape. The inner surface 141Ga of the first inclined portion 141G and the inner surface 142Ga of the second inclined portion 142G are formed in the same continuous cylindrical surface shape.

As described above, the first circumferential edge portion 131G has the first inclined portion 141G and the second inclined portion 142G as inclined portions formed to be inclined with respect to the axial direction of the cylindrical portion 72G and serving as the first end part of the edge 101G in the axial direction of the cylindrical portion 72G.

The edge 101G of the communication hole 91G is formed so that the first end part side in the axial direction of the cylindrical portion 72G is narrower than the second end part in the axial direction of the cylindrical portion 72G.

The bumper cap 13G having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13G serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72G in the axial direction of the cylindrical portion 72G and in a direction away from the space forming the lid portion 70. That is, the material flows through the space of the cavity forming the cylindrical portion 72G in the axial direction of the cylindrical portion 72G from the second end part side toward the first end part side.

The edge 101G of the communication hole 91G is formed so that the first circumferential edge portion 131G side constituting the first end part positioned downstream is narrower than a portion on a second circumferential edge portion 132 side constituting the second end part positioned upstream through which the material flows in during molding. In other words, the communication hole 91G of the bumper cap 13G is formed so that the first end part side positioned downstream is narrower than the second end part positioned upstream through which the material flows in during molding. Also, the edge 101G of the communication hole 91G of the bumper cap 13G is formed so that the second circumferential edge portion 132, which is an upstream end part of the material that flows in during molding, is substantially perpendicular to the flow of the material. The communication hole 91G of the bumper cap 13G has a tapered shape in which the first end part positioned downstream in a flow direction of the material during molding becomes narrower toward the downstream side.

The bumper cap 13G of the eighth embodiment is formed such that the edge 101G of the communication hole 91G provided in the cylindrical portion 72G is narrower on the first end part side positioned downstream than at the second end part positioned upstream through which the material flows in during molding. Therefore, the bumper cap 13G can increase a joining angle when the material flowing on both sides of a mold portion forming the communication hole 91G joins on the downstream side, thereby allowing the material to join smoothly. Therefore, the bumper cap 13G can suppress a decrease in strength due to occurrence of weld lines which are surface defects that appear on a surface as grooves or patterns at a portion in which the material joins. Therefore, durability of the bumper cap 13G can be improved.

Further, in the edge 101G of the communication hole 91G of the bumper cap 13G, it is also possible to make a portion on the second end part side including the second circumferential edge portion 132 mirror-symmetrical to a portion on the first end part side including the first circumferential edge portion 131G.

### Ninth Embodiment

A ninth embodiment according to the present invention will be described mainly on the basis of FIG. 12, focusing on differences from the third embodiment. Further, parts common to those in the third embodiment will be denoted by the same terms and the same reference signs.

In the ninth embodiment, as shown in FIG. 12, a bumper cap 13H, which is partially different from the bumper cap 13B of the third embodiment, is used instead of the bumper cap 13B. The bumper cap 13H has a cylindrical portion 72H, which is partially different from the cylindrical portion 72B, instead of the cylindrical portion 72B. The cylindrical portion 72H has a communication hole 91H, which is partially different from the communication hole 91B, instead of the communication hole 91B. The communication hole 91H allows communication between an outer circumferential surface 72Hb and an inner circumferential surface (not shown) of the cylindrical portion 72H. Here, also in the bumper cap 13H, a side opposite to a lid portion 70 (see FIG. 2) in an axial direction of the cylindrical portion 72H is referred to as a first end part side, and the lid portion 70 side in the axial direction of the cylindrical portion 72H is referred to as a second end part side. Also, in the communication hole 91H, an end part on a side opposite to the lid portion 70 in the axial direction of the cylindrical portion 72H is referred to as a first end part, and an end part on the lid portion 70 side in the axial direction of the cylindrical portion 72H is referred to as a second end part.

The first axial edge portion 102B and the second axial edge portion 103B are not provided in the edge 101H of the communication hole 91H. The edge 101H has a first circumferential edge portion 131H instead of the first circumferential edge portion 131B. The first circumferential edge portion 131H has a first inclined portion 141H instead of the first inclined portion 141B, and has a second inclined portion 142H instead of the second inclined portion 142B.

The first inclined portion 141H extends from one end of a second circumferential edge portion 132B in a circumferential direction of the cylindrical portion 72H. The first inclined portion 141H, including an inner surface 141Ha that faces a space in the communication hole 91H, is linear. The inner surface 141Ha of the first inclined portion 141H also extends in a radial direction of the cylindrical portion 72H and is flat.

The first inclined portion 141H extends in a direction of the first end part in the axial direction of the cylindrical portion 72H from one end of the second circumferential edge portion 132B in the circumferential direction of the cylindrical portion 72H. Moreover, the first inclined portion 141H approaches the other end in the circumferential direction of the cylindrical portion 72H of the second circumferential edge portion 132B in the circumferential direction of the cylindrical portion 72H as it is positioned further on the first end part side in the axial direction of the cylindrical portion 72H. The inner surface 141Ha of the first inclined portion 141H extends in a direction of the first end part side in the axial direction of the cylindrical portion 72H from one end of an inner surface 132Ba of the second circumferential edge portion 132B in the circumferential direction of the cylindrical portion 72H. Moreover, the inner surface 141Ha of the first inclined portion 141H approaches the other end in the circumferential direction of the cylindrical portion 72H of the inner surface 132Ba in the circumferential direction of the cylindrical portion 72H as it is positioned further on the first end part side in the axial direction of the cylindrical portion 72H.

The second inclined portion 142H extends from the other end of the second circumferential edge portion 132B in the circumferential direction of the cylindrical portion 72H. The second inclined portion 142H, including an inner surface 142Ha that faces a space in the communication hole 91H, is linear. The inner surface 142Ha of the second inclined portion 142H also extends in the radial direction of the cylindrical portion 72H and is flat.

The second inclined portion 142H extends in the direction of the first end part in the axial direction of the cylindrical portion 72H from the other end of the second circumferential edge portion 132B in the circumferential direction of the cylindrical portion 72H. Moreover, the second inclined portion 142H approaches one end in the circumferential direction of the cylindrical portion 72H of the second circumferential edge portion 132B in the circumferential direction of the cylindrical portion 72H as it is positioned further on the first end part side in the axial direction of the cylindrical portion 72H. The inner surface 142Ha of the second inclined portion 142H extends in the direction of the first end part side in the axial direction of the cylindrical portion 72H from the other end of the inner surface 132Ba of the second circumferential edge portion 132B in the circumferential direction of the cylindrical portion 72H. Moreover, the inner surface 142Ha of the second inclined portion 142H approaches one end in the circumferential direction of the cylindrical portion 72H of the inner surface 132Ba in the circumferential direction of the cylindrical portion 72H to be connected to the inner surface 141Ha of the first inclined portion 141H as it is positioned further on the first end part side in the axial direction of the cylindrical portion 72H. The second inclined portion 142H is aligned with the first inclined portion 141H in position in the axial direction of the cylindrical portion 72H to form a mirror symmetrical shape. An angle formed by the inner surface 141Ha of the first inclined portion 141H and the inner surface 142Ha of the second inclined portion 142H is an acute angle.

As described above, the first circumferential edge portion 131H includes the first inclined portion 141H and the second inclined portion 142H as inclined portions formed to be inclined with respect to the axial direction of the cylindrical portion 72H and extending through in the axial direction of the cylindrical portion 72H of the edge 101H.

The edge 101H of the communication hole 91H is formed so that the first end part side in the axial direction of the cylindrical portion 72H is narrower than the second end part in the axial direction of the cylindrical portion 72H.

The bumper cap 13H having the shape described above is formed by injection molding of a synthetic resin material or die casting of an aluminum alloy material, similarly to the bumper cap 13. In either case of injection molding or die casting, similarly to the bumper cap 13, a portion of a cavity that forms a through hole 81 (see FIG. 2) of the lid portion 70 (see FIG. 2) of the bumper cap 13H serves as an inlet for the material. Then, when the material is caused to flow into the cavity from the inlet, the material flows through a space of the cavity forming the lid portion 70 to spread outward in a radial direction of the lid portion 70, and then flows through a space of the cavity forming the cylindrical portion 72H in the axial direction of the cylindrical portion 72H and in a direction away from the space forming the lid portion 70. That is, the material flows through the space of the cavity forming the cylindrical portion 72H in the axial direction of the cylindrical portion 72H from the second end part side toward the first end part side.

The edge 101H of the communication hole 91H is formed so that the first circumferential edge portion 131H side constituting the first end part positioned downstream is narrower than a portion on the second circumferential edge portion 132 side constituting the second end part positioned upstream through which the material flows in during molding. In other words, the communication hole 91H of the bumper cap 13H is formed so that the first end part side positioned downstream is narrower than the second end part positioned upstream through which the material flows in during molding. Also, the edge 101H of the communication hole 91H of the bumper cap 13H is formed so that the second circumferential edge portion 132B, which is an upstream end part of the material that flows in during molding, is substantially perpendicular to the flow of the material. The communication hole 91H of the bumper cap 13H has a tapered shape that becomes narrower as it is positioned further downstream in a flow direction of the material during molding.

The bumper cap 13H of the ninth embodiment is formed such that the edge 101H of the communication hole 91H provided in the cylindrical portion 72H is narrower on the first end part side positioned downstream than at the second end part positioned upstream through which the material flows in during molding. Therefore, the bumper cap 13H can increase a joining angle when the material flowing on both sides of a mold portion forming the communication hole 91H joins on the downstream side, thereby allowing the material to join smoothly. Therefore, the bumper cap 13H can suppress a decrease in strength due to occurrence of weld lines which are surface defects that appear on a surface as grooves or patterns at a portion in which the material joins. Therefore, durability of the bumper cap 13H can be improved.

Further, in the edge 101H of the communication hole 91H of the bumper cap 13H, it is also possible to make the second circumferential edge portion 132B mirror-symmetrical to the first circumferential edge portion 131H.

### INDUSTRIAL APPLICABILITY

According to the above-described aspects of the present invention, it is possible to provide a bumper cap and a shock absorber in which durability can be improved. Therefore, industrial applicability is high.

### REFERENCE SIGNS LIST

11 Shock absorber
13, 13A to 13H Bumper cap
21 Cylinder
32b Axial end surface
40 Piston
50 Piston rod
70 Lid portion
72, 72A to 72E Cylindrical portion
72a Inner circumferential surface
72b, 72Ab to 72Hb Outer circumferential surface
81 Through hole
91, 91A to 91H Communication hole
101, 101A to 101H Edge
102, 102A, 102B, 102D, 102E First axial edge portion
103, 103A, 103B, 103D Second axial edge portion
112, 112A First chamfered portion
113, 113A Second chamfered portion
122, 122A Third chamfered portion
123, 123A Fourth chamfered portion
131, 131A to 131H First circumferential edge portion
141, 141D First inclined portion
142, 142D Second inclined portion
143, 143A Fifth chamfered portion

1. A bumper cap, which is used for a shock absorber, in which the shock absorber includes:
a cylinder;
a piston provided in the cylinder; and
a piston rod having one end connected to the piston and a another end extending from the cylinder,
the bumper cap, which is provided at an end part of the cylinder on a side from which the piston rod extends and formed by die casting or injection molding, comprising:
a lid portion coming into contact with an axial end surface of the cylinder and having a through hole through which the piston rod is inserted;
a cylindrical portion having a cylindrical shape provided radially outward from the through hole and covering at least a part of an outer circumferential surface of the cylinder; and
a communication hole provided in the cylindrical portion and allowing communication between an inner circumferential surface and an outer circumferential surface of the cylindrical portion, wherein
an edge of the communication hole includes:
a circumferential edge portion extending in a circumferential direction of the cylindrical portion; and
an axial edge portion extending in an axial direction of the cylindrical portion, and
the circumferential edge portion is formed such that a first end part positioned on a downstream side of the cylindrical portion is angled more acutely than a second end part positioned on an upstream side of the cylindrical portion through which a material flows in during molding.

2. The bumper cap according to claim 1, wherein the edge of the communication hole is formed so that an upstream end part of the material which flows in during molding is substantially perpendicular to a flow of the material.

3. The bumper cap according to claim 1, wherein a corner of the communication hole is chamfered.

4. The bumper cap according to claim 1, formed of a metal or a resin.

5. A bumper cap, which is a bumper cap for a shock absorber including:
a cylinder;
a piston provided in the cylinder; and
a piston rod having one end connected to the piston and another end extending from the cylinder, and
which is provided at an end part of the cylinder on a side from which the piston rod extends,
the bumper cap comprising:
a lid portion coming into contact with an axial end surface of the cylinder and having a through hole through which the piston rod is inserted;
a cylindrical portion having a cylindrical shape provided radially outward from the through hole and covering at least a part of an outer circumferential surface of the cylinder; and
a communication hole provided in the cylindrical portion and allowing communication between an inner circumferential surface and an outer circumferential surface of the cylindrical portion, wherein
an edge of the communication hole includes:
a circumferential edge portion extending in a circumferential direction of the cylindrical portion; and
an axial edge portion extending in an axial direction of the cylindrical portion, and
at least a part of the circumferential edge portion includes an inclined portion formed to be inclined with respect to the axial direction of the cylindrical portion and serving as an end part side of the edge of the communication hole in the axial direction of the cylindrical portion, and
the circumferential edge portion is formed such that a first end part in the axial direction of the cylindrical portion is angled more acutely than a second end part in the axial direction of the cylindrical portion.

6. The bumper cap according to claim 5, wherein
the axial edge portion has a first axial edge portion and a second axial edge portion, and
the inclined portion includes a first inclined portion formed to extend at an incline from one axial end of the first axial edge portion and a second inclined portion formed to extend at an incline from one axial end of the second axial edge portion.

7. The bumper cap according to claim 6, wherein the inclined portion is provided on a first end part side in the axial direction of the cylindrical portion.

8. The bumper cap according to claim 7, wherein the inclined portion is provided on the first end part side in the axial direction of the cylindrical portion and on a second end part side in the axial direction of the cylindrical portion, and is formed symmetrically.

9. (canceled)

10. A bumper cap according to claim 5,
formed of a metal or a resin.

11. A shock absorber comprising:
a cylinder;
a piston provided in the cylinder;
a piston rod having one end connected to the piston and another end extending from the cylinder; and
a bumper cap, wherein
the bumper cap includes:
a lid portion coming into contact with an axial end surface of the cylinder and having a through hole through which the piston rod is inserted;
a cylindrical portion having a cylindrical shape provided at a radially outer end part of the lid portion and covering at least a part of an outer circumferential surface of the cylinder; and
a communication hole provided in the cylindrical portion and allowing communication between an inner circumferential surface and an outer circumferential surface of the cylindrical portion, and
an edge of the communication hole includes:
a circumferential edge portion extending in a circumferential direction of the cylindrical portion; and
an axial edge portion extending in an axial direction of the cylindrical portion, and
the circumferential edge portion is formed such that a first end part positioned on a downstream side of the cylindrical portion is angled more acutely than a second end part positioned on an upstream side of the cylindrical portion through which a material flows in during molding.
